(19) United States
(12) Patent Application Publication
(10) Pub. No.: US 2011/0175753 A1
(43) Pub. Date: Jul. 21, 2011

(54) Robotic influenced self scheduling F.L.O.W. trafic management system

(76) Inventor: James Jacob Free, Elkhart, IN (US)

(21) Appl. No.: 12/657,256

(22) Filed: Jan. 15, 2010

(51) Int. Cl. G08G 1/08

(52) U.S. Cl. 340/917; 901/50

(57) ABSTRACT

A traffic management system is disclosed that tells motorist how fast to go in order to make it through a traffic signal while it is in green phase. A Fast Lane On Warning (FLOW) sequencer is in synchronization with traffic phases sequencer (sequencing Red, Green, Yellow, Left Turn and the like) with both sequencers having service cycle period ‘Pi’ . The start times of both sequences are appropriately offset from one another. Sensors up road from the signal provide data on approaching vehicles number per time to a processor that synthesizes the data for one or more “fast” lanes in one or more directions. Using that data, the processor influences the signal and FLOW sequencers as well as emplaced and/or mobile on-board readouts to optimize phase openings and traffic distribution and traffic activity including:
(1) To move denser traffic to leaner parts of a pattern;
(2) To change net green ‘Tng’ in multi directions contracting the Tng in lean patterns and equally expanding Tng in dense patterns in opposing directions;
(3) To change Pi and thus expand or contract all phases concurrently;
(4) To encourage increased following distances of close follower vehicles through means of speed readouts.

Thus, with optimization of FLOW patterns as they are being consolidated, there can be increased following distances, more uniform distribution, adding more places, resulting in increased safety and even more mobility than that provided by autonomous self-scheduling FLOW outputs alone.

### STATEMENT REGARDING FEDERALLY FUNDED RESEARCH AND DEVELOPMENT

Not Applicable

### REFERENCES

U.S. Pat. No. 3,302,168 Gray January 1967 340/932

U.S. Pat. No. 4,370,718 Chasek Jan. 25, 1983 364/436

U.S. Pat. No. 4,914,434 Morgan, et al Apr. 3, 1990 349/906

U.S. Pat. No. 5,278,554 Marton Jan. 11, 1994 340/942

U.S. Pat. No. 5,357,436 Chiu Oct. 18, 1994 364/436

U.S. Pat. No. 5,444,442 Sadakata Aug. 2, 1995 340/916

U.S. Pat. No. 5,696,502 Busch, et al Dec. 9, 1996 340/905

U.S. Pat. No. 5,777,564 Jones Jul. 8, 1998 340/917

U.S. Pat. No. 5,959,553 Raswant Sep. 28, 1999 340/907

U.S. Pat. No. 5,821,878 Raswant Oct. 13, 1998 340/907

U.S. Pat. No. 5,330,278 Raswant Jul. 19, 1994 404/1

U.S. Pat. No. 6,313,757 Braun Nov. 6, 1991 340/917

U.S. Pat. No. 6,424,271 Raswant Jul. 23, 2002 340/907

U.S. Pat. No. 6,496,773 Olsson December 2002 701/117

U.S. Pat. No. 6,617,981 Basinger Sep. 9, 2003 340/909

U.S. Pat. No. 6,633,238 Lemelson Oct. 14, 2003 340/909

U.S. Pat. No. 6,710,722 Lee Mar. 23, 2004 340/910

U.S. Pat. No. 7,432,826 Schwartz Oct. 7, 2008 340/902

Ser. No. 61/197,343 Free Oct. 27, 2008

Ser. No. 61/197,396 Free Oct. 27, 2008

Free, James; USING F. L. O. W. TRAFFIC MANAGEMENT METHODS TO SIGNIFICANTLY REDUCE FUEL CONSUMPTION RATES AND THE RESULTING POLLUTION; Paper Published at Intelligent Transportation Society of America Conference Washington D.C. Jun. 3, 2009 GEVAS, Audi et al, Travolution May 2008

### FIELD

This invention relates to sensor based adaptive adjustments, “mind changing” of “Fast Lane On Warning” (FLOW) sequencers. Also to sensor based adaptivity in traffic flow management.

More specifically it relates to sensor based shifting of phases, service cycle periods, individual speed readouts and optimizing for safe following distances, FLOW pattern density distributions while generating readouts that tell vehicles how fast they need to go in order to make it through a traffic signal while signal is in the green phase.

### BACKGROUND

It is becoming increasingly popular to use adaptable systems in traffic control. Loops are in the pavement, as well as video cameras on utility and traffic signal poles, supports that detect the presence of a vehicle waiting at an intersection. When a waiting vehicle is detected, processors influence the traffic signal to change. Also, sensors are becoming increasingly precise. The allied ability to count provides for an opportunity for the discernment of approaching traffic to be increasingly accurate. Sensors can thus “see” more accurately the conditions in a run up to a traffic signal: more particularly, get a precise count of traffic per time.

Gray (U.S. Pat. No. 3,302,168) anticipates the use of detectors in the infrastructure, and even addresses following distances (mainly for the purpose of safety in non visual conditions) however, there is no incentive in the form of increased mobility. Also, the system of infrastructure-embedded lights would be hard to perceive by motorist and potentially very expensive to upkeep.

Lee (U.S. Pat. No. 6,710,722) anticipates the use of certain components that may be less obtrusive to cables, traffic light supports and the like and converses about video cameras involved with association with traffic signals. Busch, et al (U.S. Pat. No. 5,696,502), uses “fuzzy logic” and mentions sensors and processors but no autonomous function or algorithm. They mention a “warning” for trouble but not the ability to influence the green phase or the like and not the ability for safer following distances to function as readouts that offer the opportunity and incentive for mobility. Like in Lee along with Busch and Gray, the inventions have no basic algorithm or autonomous mathematical structuring to support how or why the signal will do what it will do. The inventions of Lee, Busch, Gray et al also do not anticipate the application of using sensors to influence periods, phases, nor individual vehicle speed readouts that tell motorist how fast to go in order to get through during a green phase.

Chasek (U.S. Pat. No. 4,370,718) considers “aggregate momentum” “congestion factors” and “Doppler radar to velocity sensors” and apparently seeks to detect or “forecast” larger clumps of traffic like already seeming to form “platoons”. While they mention congestion factor, they provide no way to identify or work with it. Also they seem to favor trucks and busses, contributing to the “aggregate momentum” and with “ congestion and stopped” including “lengthening the signal” and “pre empted”. Chasek seems to wait for an opportunity in a block of traffic or wait for a “platoon”, or they try to identify a “platoon”. They also seem to focus on slow almost stopped traffic where at that speed, no real incentive exists for saving fuel. Also while Chasek mentions getting traffic through during green, the congestion factors they mention imply the need to accommodate for denser traffic. They do not utilize an algorithm upon which to base traffic management on, and they do not mention how to specifically adapt to congestion or denser regions. While Chasek and others address the problem of letting traffic through while green, and while they include necessary components like sensors, they lack the logic to actually solve the problem. They mention “pre empt”, while they should be working with SCHEDULING, and for adaptable systems ADJUSTING SCHEDULE.

Inventions that range from the complex to the very very complex include Raswant, Marton (U.S. Pat. No. 5,278,554), Raswant (U.S. Pat. Nos. 5,959,553; 5,821,878; 5,330,278; 6,313,757; 6,424,271), Chasek (U.S. Pat. No. 4,370,718), et al who propose a block by block grid system that manages intercity traffic. Rather than counting on an algorithm that presides over a particular intersection, they depend on a central network type of setup. If there are increasing numbers of vehicles getting through on green phases, and if there can be the possibility of SCHEDULING (as can be successfully applied with a “Green Wave”) there would be increasing programming issues generating from a central control. Along with problems of mobility, there would be an increase in danger. If there were a problem in a central control algorithm there could be the possibility of accidents. If the central control packages of data were interrupted, the light would have to revert to a red blinker, or an automatic RGY cycle. Why shouldn't it revert to an autonomous sensor based adaptive system; why shouldn't the autonomous system take precedence anyway? A safer and more mobile way of traffic managing would be to do the controlling from each intersection, maybe allow for outside network influences but do the sensor based control from each of those intersections based on local intersection conditions.

Lamelson et al (U.S. Pat. No. 6,633,238) mentions using “congestion parameters” and weather sensors. Their output consists of “warning signs” as opposed to speed assignment or speed readout. Lemelson lacks any king of logic or a straightforward scheduling algorithm that tells motorist particularly how fast to go in order to make it through the Green phase. They also do not have any adaptations based on sensors intended to get more traffic focused into a net green space or time. Also, Lemelson's sensors seem to be mounted on the signals themselves and could not function as an adaptive FLOW system where the sensors would need to be far up road from the signal to have an impact on readouts that tell motorist what speeds to go in order to get through the green phase of a traffic signal. They do not mention adaptive addition of vehicles and following distances, phase changes, service cycle changes and the like. Lemelson mentions many components of the needed hardware: processors, sensors, “intelligent controller” but they lack the necessary setup of components that it would take, and they do not anticipate any logic or algorithm that would tell motorist what speed to go to get through green phase. This algorithm would be needed to serve as a base, default or background in order for adaptive or robotic enhancements to take place. In order for sensor based adaptivity to function correctly, there needs to be a function from which the adaptations develop. Also Lemelsen lacks the ability to enhance safety, safe following optimization through the initiative of the mobility as a result of changeable speed assignments that bring traffic through the intersection during green phase.

Travolution uses “evolutionary” methods but again they have no basic logic or algorithm to start with. The fact that they use video cameras at an intersection (where they imply closeness to the intersection) and mention “to within a few hundred yards” (also implying closeness to intersection), means that they address vary slow speeds as if almost considering traffic waiting at the intersections. Any kind of real incentive to save fuel and keep vehicles at a high energy level would need sensors covering greater distances form the intersection than a few hundred yards, or greater distances than fields of video cameras mounted at the intersection. Another example of very close and therefore very slow speeds is to be found in Jones (U.S. Pat. No. 5,777,564). They mention detection “near stop” applied to “accident prevention”. Much emissions can be dropped, and much fuel can be saved by spending less driving time and getting vehicles through an intersection as opposed to have them wait. However, huge and notable differences in energy consumption can gained by considering traffic-managing in the realm of “open” speed limit, as well as large proportions such as 91%, or ⅔ or 85% or 58% or the like of the “open” speed limit.

Basinger (U.S. Pat. No. 6,617,981), as well as Chu (U.S. Pat. No. 5,357,436) similar to Travolution uses “Fuzzy Logic” which might be a good means to influence or toggle a phase pattern or especially a FLOW pattern, but there is no base algorithm or logic upon which to influence. What they would need would be for a semi autonomous base algorithm upon which to do toggling, variable-rate toggling, or do influencing. Trying to toggle a straight RGY autonomy would have to happen too fast and would be dangerous; there would need to be a function associated with a long run up or trap (especially with higher speed limits) to work with network influences. There are more straightforward methods like Boolean type adjustments many times per second which are easier and more dependable, not to mention that they lend themselves to electronic circuits. Also, traffic systems would need to employ incremental Booleans, “summated Booleans” that include a complete following distance associated with the addition of a vehicle place. This would mean a “drift” that could be an individual Boolean updated or scanned many times per second based on real time incoming data from both two way directions (i.e. N-S; E-W). Then, on top of that, there would need to be asked a Boolean question “Is there enough space time for a complete following distance; Yes or No? There could be no such thing as a “partial” following distance. Such an implication brought into practice would be dangerous.

None of these inventions use a basic autonomous algorithm to pull or to favor or to influence cycle times or readouts or combinations of those. There are no algorithms and especially none that prevents the exceeding of speed limit, none that discourage cross assigning, and none that bring in traffic in as a proportion in the after-managed net green that they were in as they approached as a random pattern. That last parameter would particularly subject itself to opportunities of phase changing, leaving green open longer for traffic to go through while moving. Also, that third parameter would lend itself to pulling favoring, toggling or influencing readouts so as to maximize safety and maximize safe following distances. Also, sensor based influencing or favoring in that last parameter could lend itself to optimization within the FLOW pattern. However none of the previously mentioned inventions mention such algorithms nor do they mention such parameters. The previously mentioned inventions do not mention altering service cycle times that could optimize for safety, and safe following times.

Preemption is certainly a great way to save fuel, and is commonly known in the art, however it is used largely for emergency vehicles and their safe passage: Morgan et al (U.S. Pat. No. 4,914,434), or perhaps busses: Schwartz (U.S. Pat. No. 1,432,826). If it were able to be used by the general public for fuel saving and mobility, only a couple or few vehicles could be brought through every minute to every few minutes for higher speeds and longer run ups. It would only work when there was a lot of lane space per time available (such as the middle of the night for example). If there were any denser traffic than a vehicle every two three minutes and starting in the environment of open speed or substantial proportion of that, there could be some danger, not to mention frustrated drivers who may end up at a double phase red light! Only a scheduling algorithm as a base, then with the ability of adapting could there be the most dense traffic let through or brought through during the green phase. Adaptability along with a scheduling algorithm would be the method that allows the most traffic through during green.

Also mentioning hardware components that would work nice for adaptive FLOW systems is Sadakata (U.S. Pat. No. 5,444,442) which mentions detecting, even processing for flow rates and traffic density for the purpose of influencing traffic signals. However, in getting as many vehicles through the signal while it is green, there needs to be a SCHEDULING algorithm first. If one were to try and “influence” a straight RGY process, in other words a RGY that has a constant service cycle and constant phases, the system would not be able to adjust fast enough. There would not be enough time for the signal to adapt given a reasonably short run up or approach for perpendicular “side street” filtering in traffic not to effect, but a long enough run up or approach for any influencing to take place. To maximize mobility, traffic management systems (like Sadakata) need the combination of a SCHEDULING algorithm with ADAPTIVITY. A scheduling algorithm would tell individual vehicles what speed to go in order to make it through the signal while it is in green phase. FROM THAT POINT, the sensor based influencing of phase adjustments, service cycle adjustments, speed readout adjustments should take place. With a base scheduling algorithm, the optimum of traffic gets through while in green phase (i.e. minimum stopping, waiting), thus serving the main mobility purpose of retaining high energy level in vehicles, thus conserving energy. When adaptivity is applied to the scheduling, there can be an extra bonus of yet more mobility or moving traffic per green.

Also the important feature of the capability of redistributing and increasing service cycles, phases, readouts could maximize substantially all of the vehicles' following distances for better safety.

Like with cross reference to related application, FREE (Ser. No. 61/197,396 Oct. 27, 2008; mobile, Ser. No. 61/197,343 Oct. 27, 2008;Emplaced) while they do possess the necessary functions to drive a FLOW sequence and readouts, they are autonomous or “self scheduling”. More fuel could be saved yet, and more mobility could be had, i.e. even less waiting at a stopped light, more passing through signal while it is green could happen if the system could figure out on its own where opportunity was, and then adapt to it. In an emplaced and mobile readout, if a system knew if there was lean traffic going in a North-South and dense going in a East-West and could adjust based on sensors. There would be more “moving traffic per green”. In other words, a signaled intersection could have somewhat less fuel consumption rate and lesser pollution emissions if the Tng “knew” how to keep itself open longer to compensate for more traffic going in that lane while it “knew” there was less traffic going in an opposing lane. More safety could be had if sensors detected following distances and spread out the traffic, i.e. a more evenly distributed FLOW pattern such that the following distances were maximized per a FLOW pattern.

In cross reference to related application, FREE (Ser. 61/197,343 Oct. 27, 2008; Mobile, Ser. No. 61/197,343 Emplaced), “Emplaced” and “Mobile” system are “Self Scheduling” utilizing an autonomous system, bring up “blind spots”, “voids” or “vacated areas” in times and places where readouts do not apply. These two provide for “mathematical enhancements” that may mobilize more traffic by picking up vehicles from those vacated areas and providing readouts for them. Enhancing autonomy with adaptability will not only increase green time for moving traffic, but also allow for expansion for additional vehicle following spaces that would need to be there for additional traffic that is routed from those voids or empty spaces.

The inventions mentioned by FREE do have autonomous algorithm that self schedules net greens out of random pre traffic managed patterns. The three parameters of not exceeding the speed limit, not cross assigning, and generally compressing traffic into a net green space time in the same proportion that it was encountered as it approached the trap lend themselves to further traffic management.

What is particularly opportunistic for traffic management above and beyond that provided for by autonomous emplaced or mobile readout FLOW systems are the open spots in a FLOW pattern that may be due to the third parameter of “using the same proportion”. “Hollow Spots” within the autonomous FLOW pattern could be filled with vehicles and associated safe following distances. Lesser dense parts of FLOW patterns could receive traffic from more dense parts; FLOW patterns' phases, net greens with more traffic could be expanded while associated FLOW patterns in the opposite (perpendicular) direction with lesser traffic could be contracted; traffic within FLOW patterns could be redistributed to maximize for safe following distances; service cycles could be varied overall to allow for slower speeds and/or greater following space times. All these features could be added to that base algorithm in order to increase safety and safe following distances as well as increase green time per moving traffic and thus save more fuel and increase mobility.

### Objects of the Invention

It is therefore an object of this invention to provide for an adaptive system based on sensory input that tells vehicles approaching a signaled intersection what speed to go in order to get through the intersection while the signal is green.

Also, it is an object to provide that base as a straightforward function and to provide the adaptations as simple straightforward algorithms like simple Boolean algebra in lieu of complex programs and “fuzzy logic” and so on . . . .

Another object is to provide for better mobility and more safety by smoothing out abrupt changes in FLOW readouts-based-driving

Another object is the use of sensor based adaptability that can account for even more traffic mobilized from the voids or non assignment regions (time and space) of an FLOW system and collect turn-ons, stragglers from the previous FLOW pattern and other forms of wayward traffic.

Further it is an object to provide for basic necessary parameters of not exceeding the speed limit; not having cross assignments; and starting compression with the same general proportion during compression as was encountered before traffic management occurred. And also, because of that third parameter to provide for the capability of filing in empty or less dense parts of a FLOW pattern.

Another object is to provide for adaptations to influence service cycle periods, phases, and even readouts in order to better distribute traffic within pattern.

Another object is to provide for more safety by expanding following distances in net green, and to provide for more mobility by contracting spaces or adding spaces to the net green.

Further, it is an object to provide for more clarity by adding or subtracting time in the net green by increments including following distances, and to increase safety by not involving motorist in fragments of a typical following distance.

Another object is to provide for traffic management before or during compression in an environment of distinct threshold where compression begins or just as easily a looser interpretation of where compression begins.

Further, it is an object of this invention to provide for more filling with traffic (including their safe following distances) each net green optimally in opposite (perpendicular) directions by being able to expand net green in one direction and equally contract it in the other.

Another object is to detect individual vehicles too close to one another and try and spread them out via readouts and thus to create safer following distance FLOW readouts that may discourage tailgating.

Still, it is another object to provide for an independent control over an independent intersection including sensor based adaptability using a background algorithm as a starting position.

Also, it is another object to provide for an autonomous robotic adaptive system that could be a component in a bigger network or have a manual or partial manual input by enabling the system to be toggled and also toggling at variable rates and variable priorities, with such toggling being able to influence phases, service cycles, readouts and the like.

Another object is to provide for a parasite installation in an existing self scheduling FLOW system.

Another object is to provide for the capability of consolidation and compression for either a feeding in condition as well as a substantially grouping together unified condition of admitting traffic through from one state to the next.

It is another object to be able to direct traffic towards a small time interval or a point as the net green and therefore adapt in case of low resolution of readout per time.

Another object is to provide for the ability to contract, expand, shift, redistribute, alter, in part or whole, in either direction, singly, or in multiples, FLOW traffic to better distribute it, create better following distances, allow for more traffic in the same or alternate directions, from dense to lean.

Another object is to provide for a system that reduces fuel consumption as a function of the infrastructure by increasing the ratio of green time per moving traffic, allowing more vehicles to remain in the high energy state while not having to come to a stop.

Other objects will become apparent upon further disclosure of the invention

### Description of the Invention

A robotic or adaptive FLOW (Fast Lane On Warning) system uses as a base or default or background a general autonomous algorithm that tells traffic what speed to go in order to make it through the traffic signal while green. The initial conditions of the autonomous part of the system include three main parameters:
1. That the speed limit is not exceeded as a function of any readouts or traffic managing, consolidation or compression.
2. That there is no cross assigning where the vehicle speed assignments may cause any to overtake one another during FLOW compression or traffic managing.
3. That traffic management which includes any kind of compression or consolidation places vehicles in a hierarchy that is proportional to the random pattern that occurred before any traffic management took place.

The third parameter leaves the opportunity for further movement within the FLOW pattern in that as random traffic approaches there can be instances of both open spots as well as close followers and further there could be dense areas of traffic as well as lean. The equation involving the basic parameters is:

$$Vsa = \frac{X}{( Pi - Pa ) + Pi + pgS - [ 1 - \frac{( Pi - Pa )}{Pi} ] Tng}$$

where:

Vsa is output of speed assignment,

X is position or distance to the traffic signal,

pgS is a safety buffer time period where earlier arrivals can be accounted for that also results

in a safety “extra” following distance,

Pi is service cycle of the traffic signal,

Pa is arrival point in time where X is taken, Pi>Pa>0

In keeping faithful to the second parameter and especially taking opportunity from the third parameter there can be shifting around of traffic in a FLOW pattern. There can be expansion/contraction of phases. Also, there can be expansion/contraction of whole service cycle periods.

Traffic might be able to be shifted within a FLOW pattern in order to get even more mobility or moving traffic per green as well as to optimize following distances and density distribution.

The shifting takes place by movement within the condensing FLOW pattern or even before compression; the shifting is dictated by:

$${𝕏}^{″} or \frac{{d}^{2} X}{d {t}^{2}} or \frac{d ( Vsa )}{d t}$$

leaving the equation for robotic adaptability as:

$$Vsa = \frac{X}{( Pi - Pa ) + Pi + pgS - [ 1 - \frac{( Pi - Pa )}{Pi} ] Tng} \pm \frac{{d}^{2} X}{d {t}^{2}}$$

On the third condition the hierarchy might be maintained, but being able to shift, optimize or move traffic around can further the amount of green time, further the mobility, improve the safety.

The adaptive characteristics that supplement the autonomous base include the following:

1. Sensors, counters and the like provide an input of the traffic conditions, density count, density details (i.e. places within a Pi where there are close followers, or places in the Pi where the count/density may be low as well as places in the Pi where the count/density may be high).

2. The hierarchy within the limits of the FLOW pattern can be shifted around to maximize following distances, and more evenly distribute the traffic including:
better following distance close follower detected, readings “spread”
evening out the density distributions (making following distances the same)

3. The FLOW pattern can be expanded, contracted, shifted including:

Pi changes

trading phases for FLOW lanes that take turns going through Tng expanding Tng in one direction where higher count was sensed expanding Red phase, shrinking Tng where lesser density per time in opposite (perpendicular) direction

Tng back shift for static waiting

Tng for shifts forward

Tng back shift for mathematically enhanced stragglers of previous FLOW pattern

Tng for partial additional compression from pattern front

Tng for partial shifts from pattern rear

Other partial or whole shifts (i.e. bringing in or expanding both ends of pattern, and so on)

This robotic influenced system uses sensors and programming capabilities, manual or network inputting (toggling) to influence or pull in one or another direction:

1. The physical length of moving F L O W Pattern.

2. The arrival instances of the FLOW Pattern.

3. The time-open duration, physical length of a FLOW Pattern and of a traffic signal in accordance with those changeable patterns.

4. The coordination of FLOW Patterns coming in opposing pattern directions (i.e. perpendicular where EW is one pattern, and NS is another). In other words, expanding one Tng and contracting the other for dense and sparse traffic respectively.

5. The individual vehicles in a FLOW pattern thus optimizing the following distances for each and optimizing and evening out the distribution.

Sensor frequency can range from what is a reasonable frequency to adequately function adaptively from a single unit to an entire system that takes many thousands or more scans per second, providing for a “vision”.

The types may include light or electromagnetic curtain, infrared, ultraviolet, other magnetic non visible spectrum, radio, RADAR, video, pixel variation rate analysis, magnetic, pneumatic, sonic, audio, other motion detecting means and the like.

Sensors working in opposite (perpendicular) directions would be able to influence phases and initiate tradeoff in particularly the net phase of the green Tng (and indirectly Red, and other phases) so that denser traffic heading in lane or lanes of a particular direction (i.e. N-S) could influence Tng of that direction to expand (i.e. the N-S) while at the same time the Tng of the opposite (perpendicular) dirction (i.e. E-W) will be appropriately contracted.

In some cases, it might be dangerous to include a “partial” following distance. To counter this, the system could optionally lend itself to make movements in full increments that include safe following distance. In other words, if increment movement is in effect there would not be another space added to an expanding (contracting) Tng until there was enough room for a full following distance. This feature would use a Boolean “drift” in association with full following distances. It could be applicable to expanding, contracting periods, phases including uniform expanding (contracting) Tng in all directions as well as tradeoff Tng for better filling of patterns in opposing directions that take turns going through green phase.

Safety buffers at either end of Tng could absorb the “partial” following distance, place or slot until the drift accumulated enough space (time) to add a full following distance.

Sensor as well as manual based influences can be employed to modify and influence service cycle Pi, as well as the overall speed schedules that relate to them. If there were suddenly bad weather or if there were a scheduled influx of traffic (rush hour, game getting out, or the like), it may be in the best interest to slow down the speed readouts from the safe speed limit (the highest readout) down to the lowest readout, and proportionately spread out the service cycle period of the traffic light Pi. Even the distance to the node from the intersection could be expanded or contracted, especially in a situation where the node is less distinct and there is more of a range at which readouts, compression begin to take place. This feature could be toggled automatically, toggled manually or scheduled, or hooked up to conditional sensors (i.e. weather), or the like.

If a Pi increases all phases in both directions increase. The advantages of being able to increase Pi include “longer Pi; slower speeds”, “longer Pi; faster speeds”, “shorter Pi, slower speeds.

For longer Pi; slower speed assignments, the reaction time would be multiplied since the slower speeds with the same following distances would add reaction time. And expanded length of “place or “slot” would add to reaction time as well. This combination could work for situations such as immediately after the start of rain, ice, snow, and so on.

Longer Pi with faster speed assignments would simply allow for faster speeds while being capable preserving the same reaction time.

Shorter Pi with slower speed assignments also could preserve reaction time but increase safety due to slower speeds. The shorter Pi/slower assignment combo could also recover from the first mentioned characteristic of longer Pi/slower assignment, but caution should be observed in that there should not be too close a space time or reaction time too small.

Also, while Pi changes and the overall speed assignment schedule changes, the absolute node threshold distance to intersection would “breathe”; longer places would imply longer distances. And the opposite would apply for short. If there would be robotic effects on the node distance, the system might benefit from a “node buffer” for absolute nodes and may benefit from a looser node interpretation as well.

Space may be needed at the beginning of the developing patterns for static traffic waiting at the intersection as well as extra wayward traffic being added to the pattern. To deal with this there are many possibilities including straight shifting of the pattern backwards from the regular compression, either partially or fully altering the speed assignments, so that the ones in the forward part of the pattern are shifted the furthest back to make way for the additional vehicles. If too much static waiting traffic is sensed, the traffic is nudged further towards the rear of the FLOW Pattern.

Precision in sensors will also allow for better distribution within a FLOW lane. If one part or another of a FLOW distribution or pattern were detected to be too dense (i.e. too much traffic count per time), the processor would modify the assignments of the denser part to be moved to the leaner part. So not only would the pattern receive information that would inform it to go certain speeds to get through green, but the distribution would be fine tuned to optimally even itself out so that following distances would be additionally maximized (over individual close follower detection)

If sensors were particularly precise, following distances would be able to be improved where the FLOW readouts actually influenced better reaction time safety distances. If a vehicle was too close to a vehicle ahead in a FLOW lane, that closeness would be detected, the FLOW readouts would not only inform the proper speeds to go in order to make it through in green, but slightly modify those readouts to the following vehicle making them a little slower, or slightly modify the speeds of the lead vehicle making them a little faster.

The most rudimentary speed assignment schedule for a FLOW pattern would have speed assignments feeding in from one state to the next. For example, the state of going the speed limit in random pattern in pre-consolidation to consolidation/compression; the state of compression to going a constant speed or regaining the speed limit after going through the intersection, and so on.

To make the system more effective during this type of synthesis, a differential approach would be applied. With consideration to differential feeding, different requests (i.e. “fill this open space a little better”) can effect differing parts of a FLOW pattern in different states, and especially lend itself to partial influencing of a pattern.

If the end of compression occurs somewhat before the intersection, aggregate velocity of FLOW pattern at the end of a compressing process could be made constant with all vehicles going somewhat at the same speed near the intersection. Here, the “feeding in” effect might be minimized.

The more the vehicles could be going the same speed (i.e. after compression), the more they could focus on safely passing through an intersection. The vehicles could be together in a “school of fish” type scenario, especially as they go through the green phase. To achieve this, settings could be made where for example, the compression was finished well before the approach to the intersection. Here, there could be a change in the assignments to make most or all the pattern go a constant speed as it crossed the intersection, in other words, the feeding or spilling can be pretty much complete. This would encourage constant following distances where the vehicles would be closest. After going through the intersection, there could be a spilling dispersal possibility.

Along the same lines, going into the trap: if the compression started later than traffic managing, there could be more similarity in the following distances before compression and thus compression could take place more safely.

Sudden speed changes that would replace sharp corners in a chart of speed vs. time can be smoothed out by sensory based readouts and/or scheduled readout enhancement patterns. The changes would make safer the speed changes from one state to another, and more safety could be gained if the velocity changes were smoother, especially at the beginning of compression where the changes were the greatest i.e. the speed vs. time chart is the “sharpest”. Also, smoothing at the end of the compression could add to safety.

Mathematically these inputs could take an otherwise straight assignment and mix it in with the equation governing the next state and gradate between the two, how much so depending on where it is in the transition. It could “round off the edges per few, or hundreds or thousands of recalculations or scans per second”.

For example, a constant speed output could mix in with Vsa=X/[(Pi−Pa)+Pi+pgS−(1−(Pi−Pa)/Pi)Tng)] formula on a gradating percentage starting at zero at a newly defined threshold or node and gradating into a 100% Vsa algorithm at the end of the gradation period and with another gradation period starting somewhere immediately before the intersection with 100% Vsa algorithm, 0% aggregate speed, and ending at the intersection of 0% Vsa and 100% aggregate velocity while going through the intersection.

In other words, at the beginning of the trap, the vehicles are still going the speed limit, the convergence begins to occur gradually, then at the end of the trap, the convergence ends gradually, and by the time vehicles go through the intersection the pattern essentially goes a constant aggregate velocity with no further convergence. There would be the possibility of some kind of readout that directs or allows for dispersal of traffic after having gone through the intersection. For any of this to happen, the vehicle would need to sense where it is accurately enough to recognize not only whether it is in the trap, but where it is within the range of the trap where the beginnings and ends of the tapering happen.

There are places within a trap (especially nearer to the intersection when compression is mature) where there can be no FLOW readings that are normally expected in a self scheduling FLOW system. This is the remaining zone outside the Tng (compressing inside the trap as FLOW Pattern approaches the signal/intersection). This is analogous to an antinode in wave physics. Adaptable sensor based FLOW system traffic can move this traffic to buffers and or shifted patterns as need arises.

Adaptability could better manage traffic above a completely autonomous scheduler especially if integrated with sensors to better enhance the empty spaces or voids. A full FLOW pattern net green Tng could be compressed further or shifted backwards into the rear safety buffer and thus leave room for straggling traffic that has been reassigned (“enhanced”) from the previous FLOW pattern.

The variation of an individual speed assignment range could be an important tool to safely and adequately place traffic into the appropriate (more than not following) FLOW pattern. Thus, this feature could provide for readouts ranging the whole way through a Pi as opposed to only receiving effective speed readouts while in a FLOW time and place range. Vehicles (i.e. straggler, out of kilter speedometer, late turn onto FLOW lane, and the like) from blind spots or voids could be given enhancements that would optimize safety. They might include the very slow assignments at first that would put a vehicle in an empty space into the next upcoming FLOW pattern. Optimal safety may next dictate that the vehicle accelerate to a higher speed then gradually slow down as the upcoming FLOW pattern begins to overtake. Then, the vehicle slows, then assumes the speed readout of the freshly formed first place in the pattern. Additional vehicles (or alternate methods for all vehicles) doing the same might have the speed assignment morph into the speed assignment place without going a higher speed than the assignment.

An autonomous FLOW has a master slave relationship with the traffic signal being the master and the readouts being the slave, both for emplaced or mobile readouts. Often there can be a sequencer timer-coupled with the RGY controller as a piggy back/parasite condition. The master slave relationship with an adaptive system has a processor that synthesizes sensory based count or density and plays the role of master to the traffic signal expanding, contracting Pi, Phases, tradeoffs and the like. The RGY sequencer in turn remains the master to the FLOW sequencer and readouts. The processor can also serve as the master directly to the FLOW sequencer and directly over the readouts as well. The processor can re-focus or reinvent or synthesize the readouts, FLOW sequences, RGY Pi until the d(Vsa)/dt is correctly outputted. Finally, under duress, the processor can revert back to autonomous FLOW readouts or straight RGY sequences, just as a typical RGY sequencer (commonly known in the art) can revert to a red blinker under duress (the FLOW sensor based adaptive, of course can revert to red blinker as well).

For robotic, the direction of the timing could be changed. If there were an event, or if there were a rush hour, two FLOWs could be set up on a populated stretch between two or more open run ups. Timing could be coordinated with FLOW at one end to favor that traffic, then switched the other way to let it back again. Examples include Events starting and ending, morning, evening traffic patterns, and so on.

Sensor based adaptive FLOW would have particular applicability in inter city and inter-networked signals. An example of synergy with a “Green Wave” would be the clarification and enhancement of FLOW patterns already in progress. If the signals are close enough that the aggregate pattern somewhat goes a constant speed, the readouts can enhance position in the FLOW pattern as well as safely distribute each individual vehicle to maximize its following distance.

If the signals are farther apart, the adaptive system can be especially effective in maintaining organization of a FLOW pattern where it might get out of focus and loose resolution otherwise.

Considering other resolution issues (where resolution is perceived readouts per time) the buffers that are on either side of the Tng (summing it up to the green phase) can account for loss of resolution. Along the same lines, Tng (in physical length as well as equation expression) can get smaller and smaller and can even drop out so that Tng becomes a point, the location of which depends on the size of pgS. The small or point size of Tng can account for loss of resolution by aiming the traffic to the place well within the limits of the standard FLOW Tng boundaries. For a low resolution situation, the smaller Tng is, the greater the odds would still be for making it through while in the green phase.

Using the adaptive operations like changing of phases, changing of Pi, modifying of readout schedules and patterns, the adaptive system could be used as a tool in inter signal networks. For example, if a concentration of vehicles were anticipated, or sensed, the phase, Pi, or readout placed could prepare in advance and be optimally sized up by the time the pattern reached the locale.

Outside network influences (as well as manual inputs) can smoothly drift the variation of Pi, Phases, Readouts as if the system were toggled. The rate of toggle (i.e. fast or slow) can also influence the characteristics depending on the urgency or priority vs. the continuity of the system (i.e. there can be no breaks in the continuity and the change cannot be too rapid, thus avoiding danger). Where applicable, a drift (which would be the product of a few, or many Boolean choices per second) can set off a secondary summated Boolean of “Is the there a complete sum of drift to yield a complete following distance yet?”, for example (i.e. that may be found with tradeoff Tng phases, and the like).

The drift can influence all characteristics of the FLOW mechanism including adaptive opening, extending contracting compensating and so on as response to manual inputs, preprogrammed inputs, network inputs, and the like.

the system can be programmed for events or occasion, changing conditions like those where density in a certain direction is anticipated to be increased, as well as manually increased i.e. “Game getting out; open up E-W patterns”. Or FLOW could be manually programmed for worsening conditions, i.e. “Getting cold, precipitation, . . . ” slow down the speed output patterns, and increase Pi for all directions or shut down the system. Toggling can also apply to times of day.

Advanced precision in sensors would provide for the ability for the influencing processor to take many scans per time (ranging from an adequate few to get a reasonable feedback up to over thousands per second; enough for a constant “vision”). Using the Vsa equation of speed assignments coupled with the principle of a loose interpretation of a node, the system can especially facilitate for adaptive actions in or before FLOW compression (i.e. where the compression begins at either a point or a range or zone).

If compression started at some place during a zone, the threshold could be considered as “moving” and X would be taken at a new place each time a mobile readout scan was done or each time an emplaced readout changed. This loose node interpretation would afford extra ability to do shifting within the FLOW pattern and the offset between the Pi of the node (as taken each time a scan was done) and the Pi of the intersection would also have to be reinterpreted.

Also, in an inter city grid, there may be opportunities for a FLOW pattern to be generated from where the traffic would be the most dense. If a pattern of traffic were released from a complete stop, i.e. where they were all waiting static at a red light, they could be released into an instant “Red Light Release” FLOW pattern. First, the static waiting pattern would have to be counted to make sure the group that was released would be lean enough. Second, the released pattern would count on the adaptive operation of moving denser traffic to leaner parts of a FLOW pattern. Third, while the pattern readouts could adapt to going faster, they could also adapt to the operations of maximizing following distances. This pattern could be used to release inner city traffic to more spread out conditions, or it could be used to introduce it to other FLOW patterns, Green Wave or the like.

### DRAWINGS

Moving on now to the drawings,

FIG. 1 shows diagram of sensor detector, processor, RGY sequencer, FLOW sequencer, traffic light sequencer, transmitter, cables and readouts as superimposed over the intersection, trap and run-up.

FIG. 2 shows the random pattern and how traffic in that pattern is compressed or consolidated into a Tng space time which will travel through the intersection while the light is green.

FIG. 3 is a chart that shows length to intersection (and could be time to intersection) vs. relative length (time) of position within the FLOW pattern.

FIG. 4 shows time differences on a feed-in situation for an “aggregate velocity” on a chart that shows relative vehicle position(time) with respect to the other vehicles in the FLOW pattern as a function of position(time) in the FLOW lane.

FIG. 5 shows a more general interpretation of the distance (time) to intersection vs. distance (time) of position in the FLOW pattern including wayward traffic directed into FLOW pattern and Tng, also including an example of cross assignment.

FIG. 6 shows that same general chart with a looser interpretation of a node also with an example of a cross assignment.

FIG. 7 shows a FLOW pattern with random unevenly distributed vehicles with varying density of traffic including vehicles with too close of following distance.

FIG. 8 shows a projection of [FIG. 7] and including the shifts that are necessary to evenly distribute the traffic in a FLOW pattern; in other words showing random traffic pattern of length Pi morphing into a pattern where traffic is more evenly distributed

FIG. 9 shows a pattern including a shift from where vehicles are to where they were and including a linearly proportional descending d(Vsa)/dt shift with maximum shift beginning at the start of the pattern and zero shift at the trailing end of the pattern; in other words, where pattern length is wholly shrunk to compensate for wayward or setting traffic and the like.

FIG. 10 shows a pattern including a shift from where vehicles are to where they were and including a linearly proportional descending d(Vsa)/dt shift with max at beginning and zero somewhere in the middle of the pattern; in other words showing where pattern length is partially shrunk to compensate for wayward or setting traffic and the like.

FIG. 11 shows a diagram of opposite (perpendicular) directions including expanding/shrinking in multi-directions to compensate for detected dense and lean traffic respectively.

FIG. 12 is a breakdown of the pattern including a diagram of a Boolean trace that when fulfilled adds or subtracts a place.

FIG. 13 is a distance (time) to intersection vs. position (time) in the pattern which includes a beginning of consolidation after the node and end to the consolidation before the intersection.

FIG. 14 shows how abrupt speed changes can be smoothed out on a chart that shows relative position (time) with respect to the other vehicles in the FLOW pattern as a function of position (time) in the FLOW lane.

FIG. 15 includes highly zoomed in detail of the relative position (time) chart, and including a method of how the transition occurs on the level of a very short distance or time period.

FIG. 16 shows a distance (time) to intersection vs. position (time) in the pattern relative to other vehicles for a pattern that is dense near the beginning and including how the dense part is evenly spread out.

FIG. 17 shows a distance (time) to intersection vs. relative distance (time) within the pattern where vehicles display too close of following distances (space times) and how assignments spread out the close followers.

FIG. 18 shows chart of increasing time vs. increasing speed assignments in a pattern including an enhancement that guides traffic from the previous Pi being guided into the present FLOW pattern.

FIG. 19 is a sketch of distance (time) to the intersection vs. relative distance (time) within the FLOW pattern that includes a straight line variation of d(Vsa)/dt with the most change at the front end of the pattern and no change at the rear.

FIG. 20 is a graph of d(Vsa)/dt vs. relative position (time) in the FLOW pattern showing straight distribution with most reduction at the front of the pattern and zero reduction at the rear of the pattern.

FIG. 21 is a sketch of distance (time) to the intersection vs. relative distance (time) within the FLOW pattern that includes reduction at the front of the pattern corresponding to [FIG. 10] and no reduction near the center of the pattern.

FIG. 22 is a graph of position of d(Vsa)/dt vs. relative position (time) in the FLOW pattern with a straight distribution and most reduction at the front and zeroing out near the center.

FIG. 23 is a sketch of distance (time) to the intersection vs. relative distance (time) within the FLOW pattern that includes a backwards shift.

FIG. 24 is a graph of position of d(Vsa)/dt vs. relative position (time) in the FLOW pattern showing the same backwards shift.

FIG. 25 is a sketch of distance (time) to the intersection vs. relative distance (time) within the FLOW pattern that includes an overall expansion of the pattern.

FIG. 26 is a graph of position of d(Vsa)/dt vs relative position (time) in the FLOW pattern showing the expansion of [FIG. 25], straight distribution, with d(Vsa)/dt=0 at center.

FIG. 27 is a sketch of distance (time) to the intersection vs. relative distance (time) within the FLOW pattern that includes contracting the pattern.

FIG. 28 is a graph of position of d(Vsa)/dt vs. relative position (time) in the FLOW pattern with the same contraction as in [FIG. 27] including straight distribution and d(Vsa)/dt=0 at center.

FIG. 29 is a graph of position of d(Vsa)/dt vs. relative position (time) in the FLOW pattern with symmetrical distribution of d(Vsa)/dt that is curved.

FIG. 30 is a graph of position of d(Vsa)/dt vs. relative position (time) in the FLOW pattern with distribution that is curved and with an asymmetrical shift to the rear.

FIG. 31 is a graph of position of d(Vsa)/dt vs. relative position (time) in the FLOW pattern with an asymmetrical straight distribution in a forward shift with distribution “touching” at d(Vsa)/dt=0 off center.

FIG. 32 is a graph of position of d(Vsa)/dt vs. relative position (time) in the FLOW pattern where there is a straight but not constant distribution while shifting backward.

FIG. 33 is a graph of position of d(Vsa)/dt vs. relative position (time) in the FLOW pattern with a non-constant shift forward and a curved distribution.

FIG. 34 is a graph of position of d(Vsa)/dt vs. relative position (time) in the FLOW pattern with a curved distribution and where d(Vsa)/dt becomes positive, negative multiple times as may be encountered by adjustment of following distances

FIG. 35 shows a comparison diagram of opposite (perpendicular) directions including where whole components (i.e. phases, traps, run-ups and the like) shrink or grow equally in both directions as service cycle Pi shrinks or grows.

FIG. 36 is an analogy including scans going in either direction and containers denoting places per Tng and two containers representing adding or subtracting a place.

### A DESCRIPTION OF A PREFERRED EMBODIMENT

The following disclosure of a preferred embodiment is proposed for the purpose of describing the invention. By no means and under no circumstances does it represent the only method or form that the invention can take.

A long ranging sensory network 1 gathers accurate count of traffic 2 per time approaching and proceeding through FLOW (Fast Lane On Warning) trap 3 which starts at distinct threshold node 4 (but which also could be a range or zone 4-b in lieu of a threshold). The trap 3 approaches a traffic signal 5 governing intersection 6 guided by a FLOW (Fast Lane On Warning) sequencer 7 with the intention of telling traffic 2 what speed to go in order to pass through intersection 6 while signal 5 is in green phase.

Sensory network 1 provides accurate count per time to be processed in sensory processor 8. If conditions warrant it, processor 8 influences 9 RGY traffic sequencer 10 to switch out fragments of phases, or lengthen/shorten service cycle periods or the like. RGY traffic signal sequencer 10 sends SPAT data 11 to FLOW sequencer 7 so that FLOW sequencer can eventually send out FLOW readouts 12 to traffic 2. Sensory processor 8 can also directly influence 13 FLOW sequencer 7 and/or associated transmitter 14 as well. Sensory processor 8 can also have direct influence 15 to mobile readouts 16. Alternatively, there could be an electrically conductive, optic or the like cable 17 coming from transmitter 14 and or FLOW sequencer 7 that reports adaptive readouts to multiple emplaced readouts 18 along with having influence 15 from sensory processor 8 still reaching readouts 16 through multiple emplacements 18. The fact that processor 8 can influence any combination of RGY sequencer 10, FLOW sequencer 7, transmitter 14, readouts 16 lends itself to a parasite or piggyback installation on already existing FLOW systems.

Also, there can be precedence where processor 8 can be master and RGY sequencer can be slave; processor 8 can be master FLOW sequencer can be slave; RGY sequencer can be master to FLOW sequencer slave; processor 8 can be master transmissions can be slave; processor 8 can be master, readouts 16 can be slave; FLOW sequencer can be master readouts and/or transmissions can be slave; and other appropriate precedence can take place including obvious one of any of components 8, 10, 7, 14, 16 having trouble that RGY takes precedence, if autonomous function has trouble, FLOW takes precedence, and red blinker (not shown) takes precedence if there is any trouble relating to safety; readouts shut down in trouble regarding safety.

In telling traffic what speed to go to get through green phase, a first random approaching pattern 19 of space time length of Pi, the service cycle (i.e. R+G+Y) of the intersection processor 10 must be considered. Compressed readouts 12 consolidate traffic from random pattern of length [Pi*(speed limit)] into a net green “Tng” space time 20 which is part of the green phase 21, while there are buffer space times before 22, and after 23 to be able to absorb wayward traffic that wanders out of net green Tng during compression 12. Other phases in an example of service cycle Pi include yellow phase 24 and red phase 25. Complete length of space and period of time for intersection passage of moving FLOW pattern is Pi 26 which is same length of random approaching pattern Pi 19 as it approaches trap 3 (in [FIG. 1]) before compression 12.

In [FIG. 3], a chart of distance along trap 3 verses relative vehicle time (distance) in the FLOW Pattern plots relative progress in compression 12 where horizontal axis is distance “X” 27 from node 4 (a node being a point where compression starts, but could also be a small zone 4-b), to intersection 6, and where vertical axis is relative position in FLOW pattern, first (left side) as random pattern time length Pi 19 (while that axis could just as easily represent length). At the left of the node 4 would be the vehicles distributed throughout the pattern before compression 12 (in [FIG. 2]), and at the right of the node 4, the vehicles plotting individual paths 29, 30, 31, 32, 33, would progress through compression, each getting closer to one another in relative time as well as distance, until they projected throughout a time (as well as distance) phase length of Tng 20 at the end of trap and near intersection 6. Before compression 12, the vehicles 34 were randomly distributed and went the speed limit. They did not gain on each other in relative time and space till after they crossed the node 4. After crossing the node 4, their relative following times and following distances converged towards one another until the whole FLOW pattern was within Tng 20. The Tng 20 is bordered by pre FLOW safety buffer pgS 22, and followed by Tsf safety following time buffer (as well as distance) 23. Once traffic cleared intersection 6 it would be able to increase speed as needed and disperse again in time and space, particularly lead by vehicles at the front of the pattern 29b the first. While through the intersection, 6 represented at that point along the trap X 27, the compressed traffic Tng 20 would go through a Pi with phases Red 25, Green 21, and Yellow 24. While traffic would be compressed in space and time, there would begin to be voids, or blind spots, “vacated areas” 35, that would form just after traffic began to cross the node 4. The function of compression is to not have vehicles where the voids 35 are, and to have the void place and time exist during the red phase 25.

Following the same general layout as in [FIG. 3], [FIG. 4] traces the same horizontal axis “X” 27 as a length along the trap, with vertical axes serving as relative time within the FLOW Pattern that could just as easily be distance. On the left would be the node 4 (threshold or zone) with Pi of a random pattern 19, and on the right would be a projection of Tng 20 (as part of a RGY Pi at intersection not shown in [FIG. 4]). The realistic progress of a flow compression in [FIG. 4] would have the FLOW pattern in a feeding out and feeding in or “spilling” of individual vehicles going at their particular assignments in “differential fashion” with first vehicle 29 arriving before next vehicle 30 which arrives before next vehicle 31 which arrives before next vehicle 32, which arrives before next vehicle 33, and until the end of the FLOW pattern. The feeding—in/out condition takes into account the possibility for vehicles entering into a stage before others while the others will be still in a previous stage. I.e vehicles at the lead of a pattern 29, 30 could be beginning to compress while those in the tail end 31, 32, 33 could still be in random traffic 34. Similarly, vehicles at the lead of a pattern 29, 30 could be beginning to compress while those in the tail end 31, 32, 33 could still be in random traffic 34. The feeding out condition could be particularly applicable to the special condition of a red light release where vehicles feed out from static waiting to the speed limit although the pattern would be more equally spaced instead of random 34.

In [FIG. 5] the same axes are used as in [FIGS. 3 and 4]: Horizontal is the distance along the trap 27 (not shown in [FIG. 5]), with vertical being a relative time (distance) between vehicles in a FLOW pattern. At left is a random Pi 19 at node 4 (not shown in [FIG. 5]), and right including a projection of net green Tng 20, with safety buffer times (distance) in front and back 22, 23, implied traffic from voids 35 is shown. Compression 12 is shown with typical vehicle paths converging to within the projection of net green Tng 20. Vehicles that would happen to be in a void would be able to be guided into buffer periods using mathematical enhancements or the like including vehicles 36, 37 especially from void before FLOW pattern (i.e. from the ‘previous’ Pi 19), being lead into forward buffer 22, and vehicles being lead from behind the FLOW pattern 38, 39, directed into after buffer Tsf 23. Cross assigning as shown with 29c is discouraged as much as possible and is more effectively dealt with using highest resolution (of readouts with respect to time) as possible.

A looser interpretation of a node 4-b (in [FIGS. 1 and 6]) might include a zone 4-b instead of a threshold or “point” 4 along the trap or run up. It could even range for a substantial part of the trap between the time of beginning of compression to the intersection 6 in [FIG. 1]. In [FIG. 6], instead of having wayward traffic 36, 37, 38, 39 arrive and be directed to localities of safety time (distance) buffers 22 and 23 in [FIG. 5], evaluation is as if there were a moving threshold with the offset between Pi at random 19 and Pi at light 26 (in [FIGS. 3 through 6]), being evaluated for each scan of position X 27 (in [FIG. 3]). With looser interpretation of node, traffic paths 29, 30, 31, 32, 33 in [FIG. 6], and including wayward traffic from voids 36, 37, 38, 39 in [FIG. 5] is all more evenly dispersed throughout Tng 20 9 in [FIG. 6]), where paths are substantially equally convergent, and there is less likelihood of overstuffing of wayward traffic into safety buffers 22, 23. As in [FIG. 5], a looser interpretation of a node still discourages cross-assigning 29-c as much as possible.

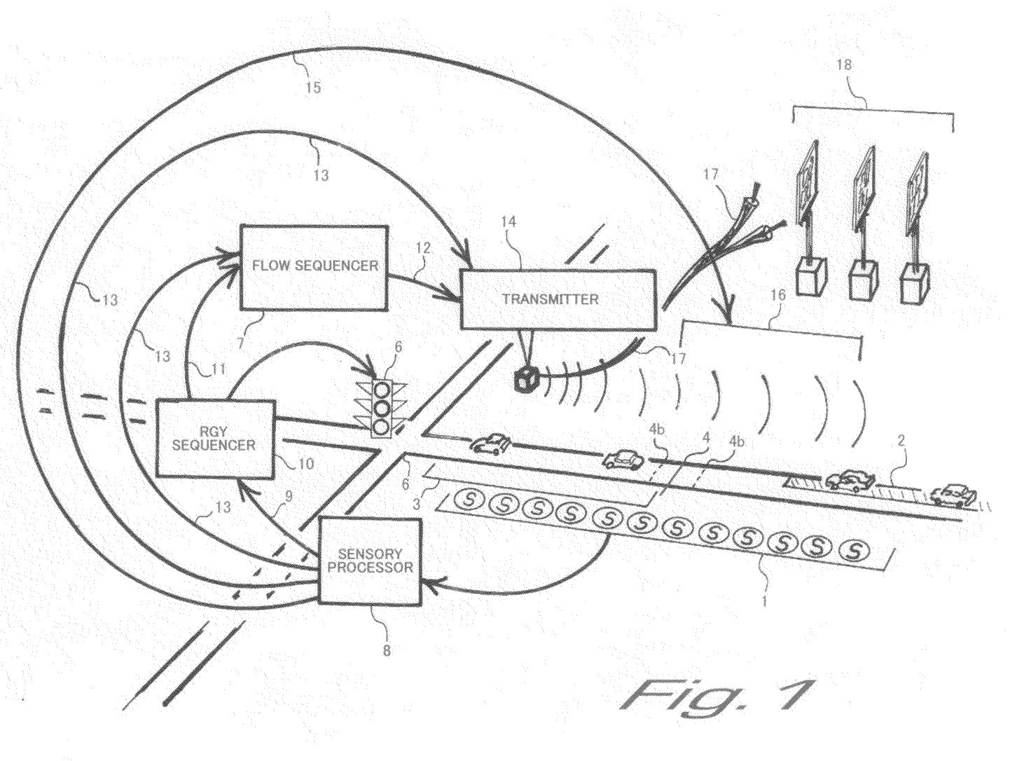

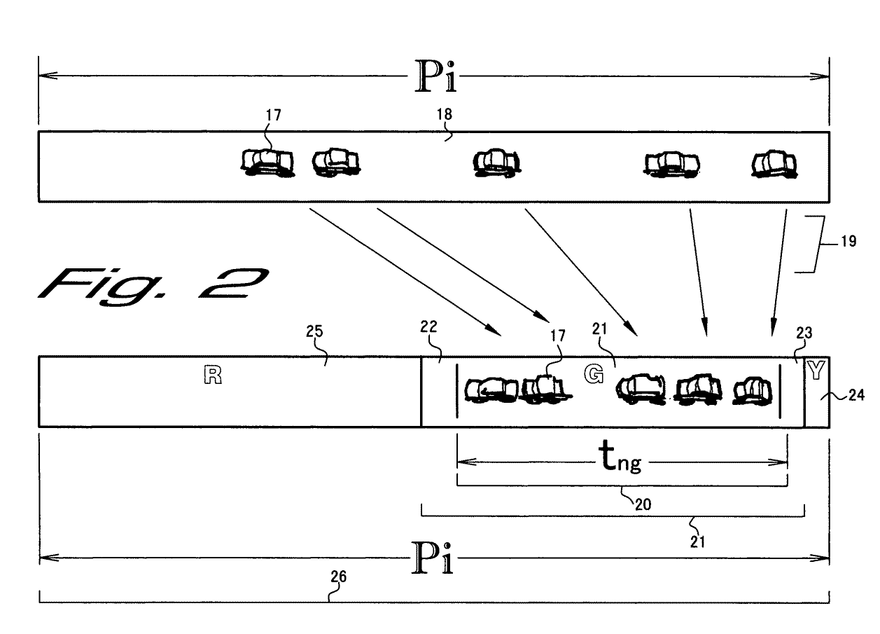

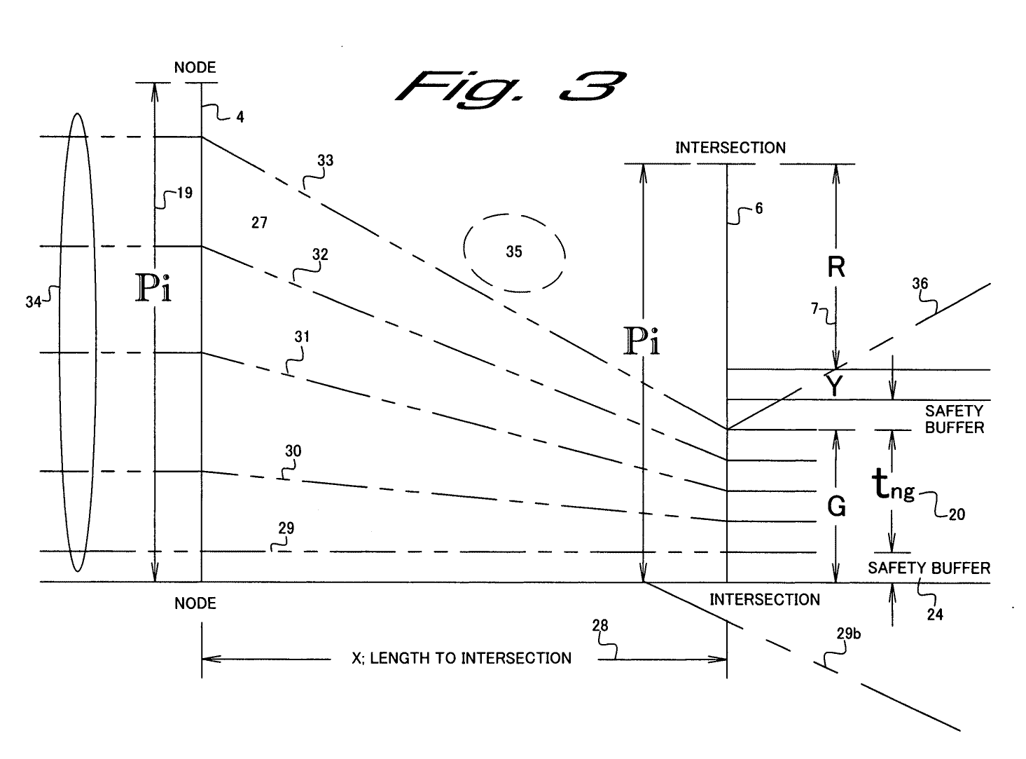

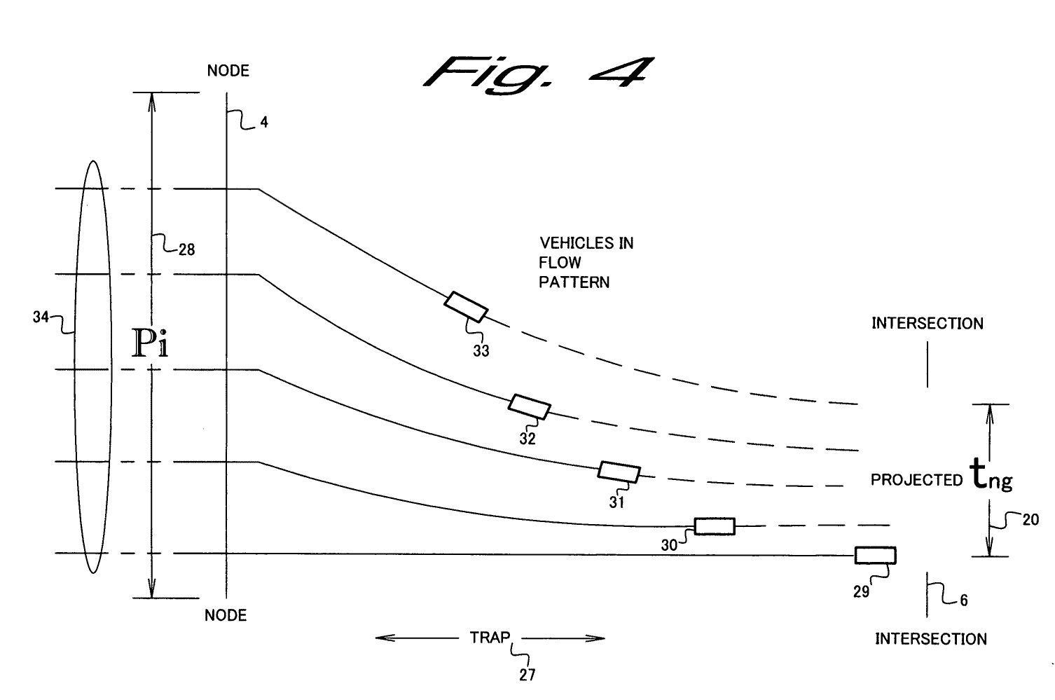

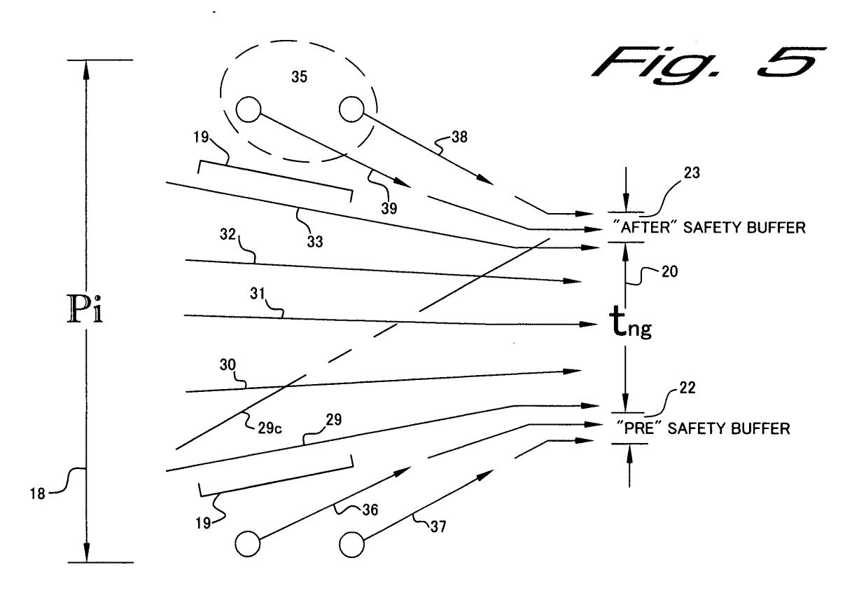

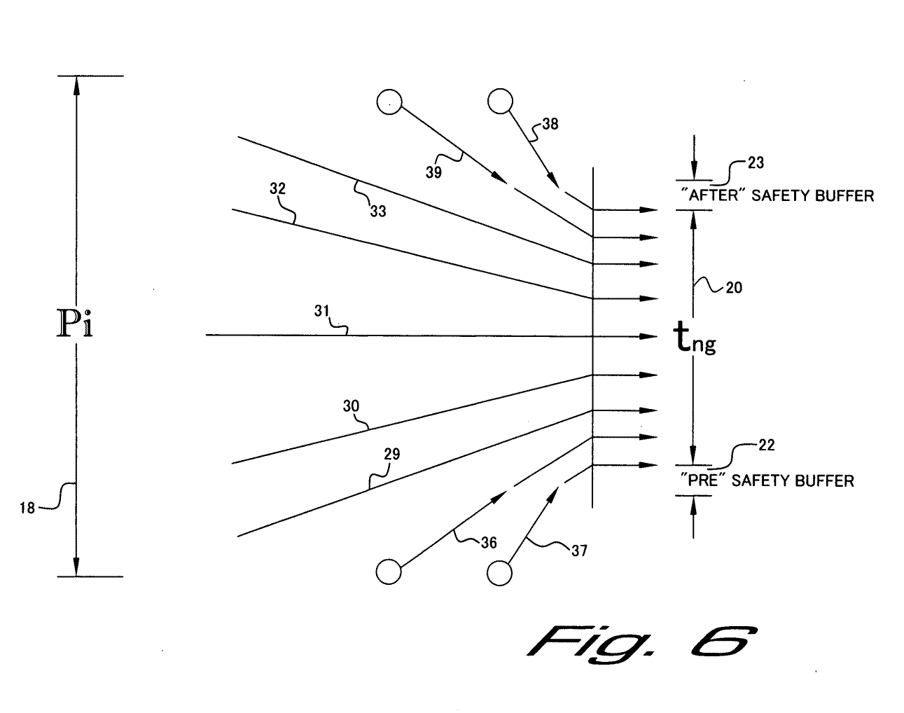

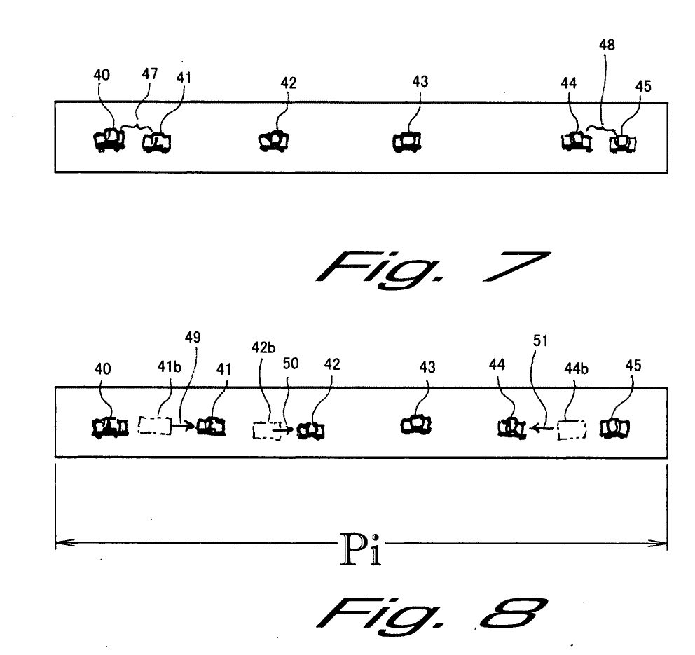

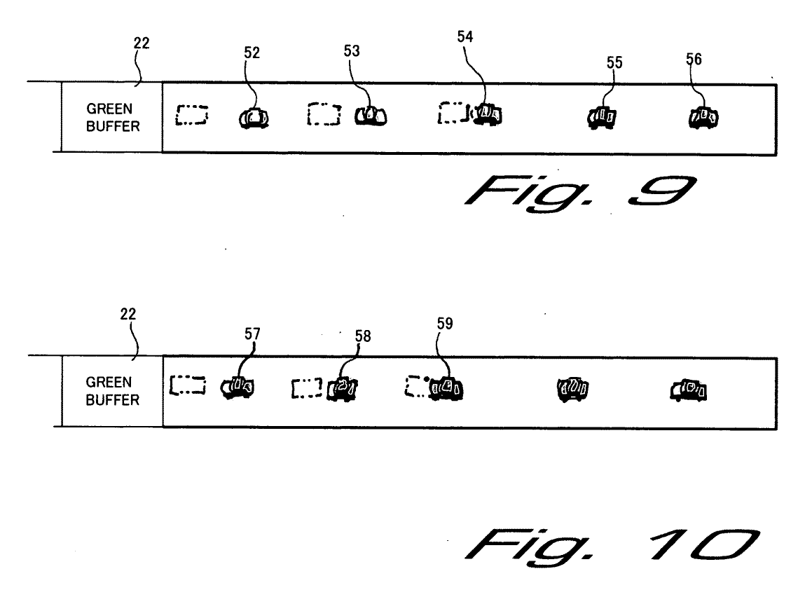

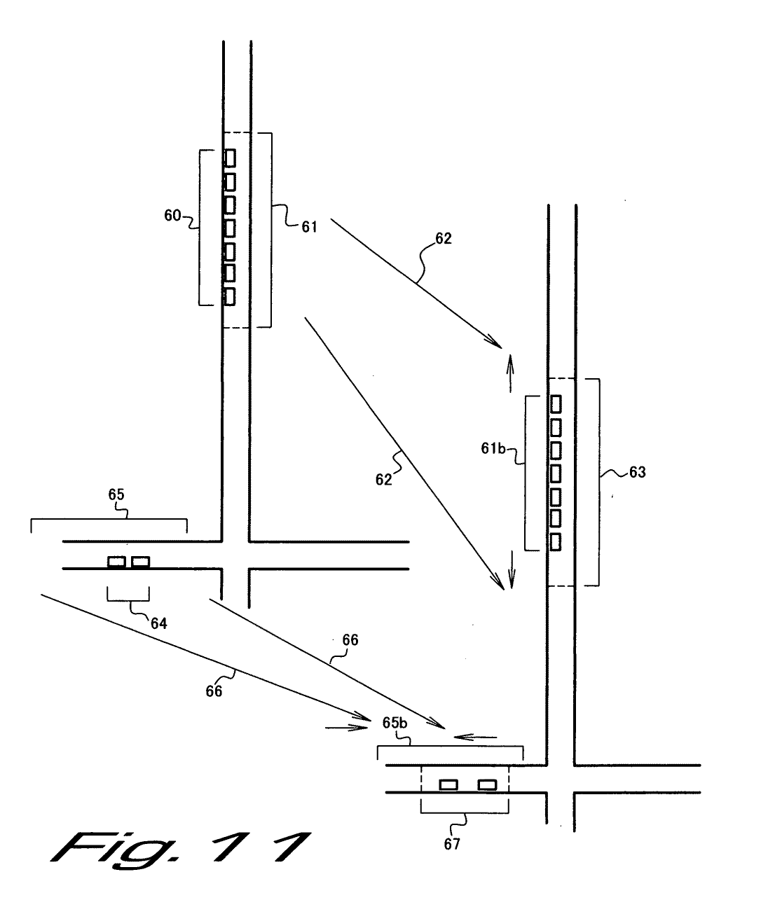

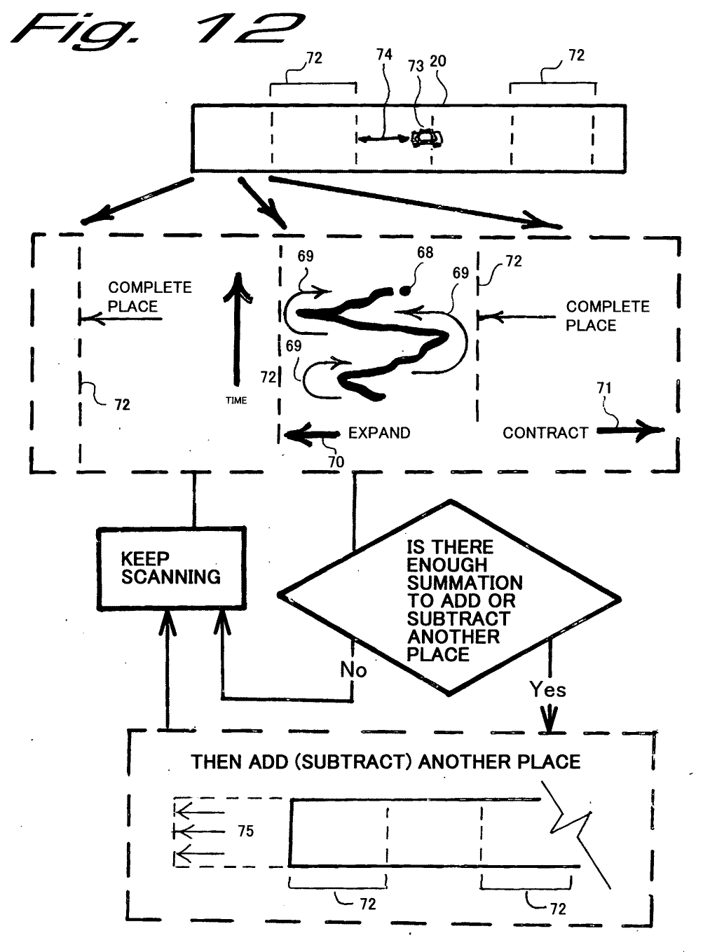

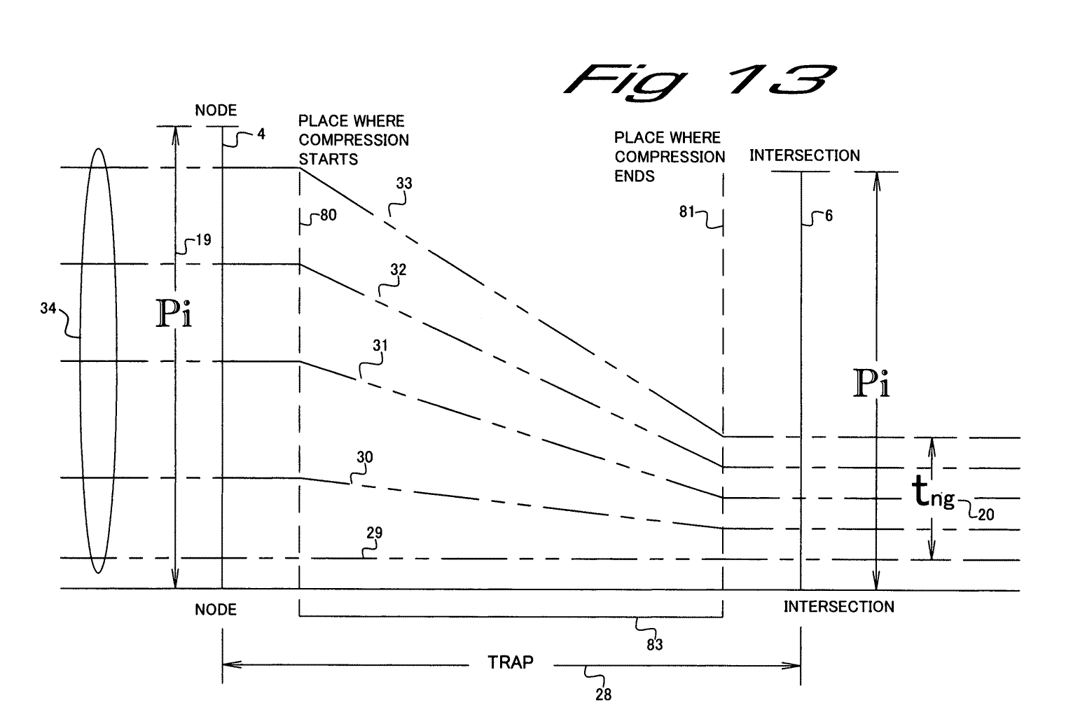

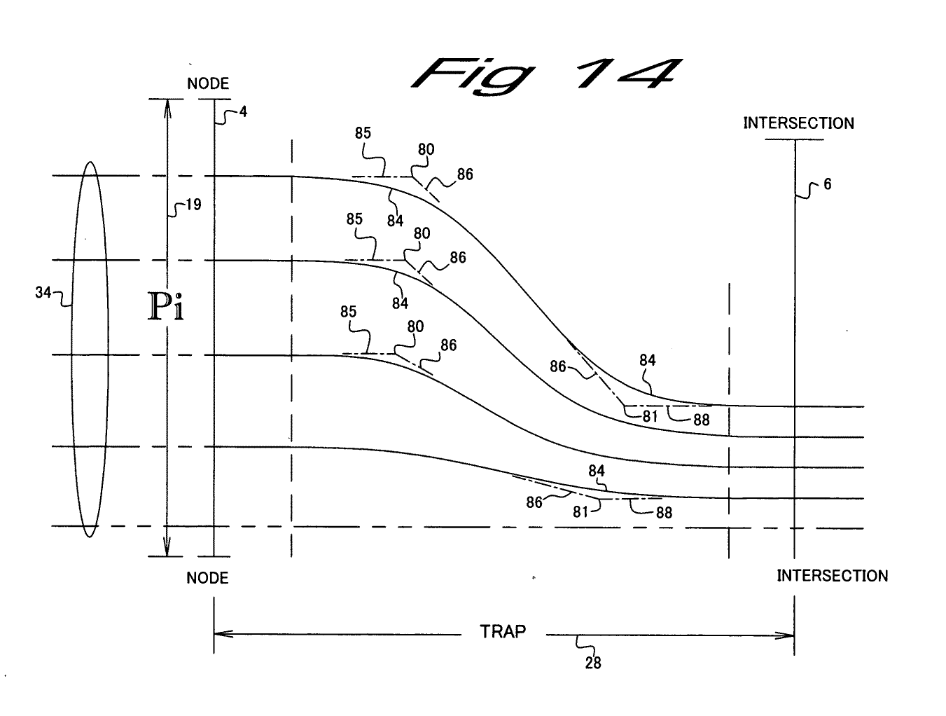

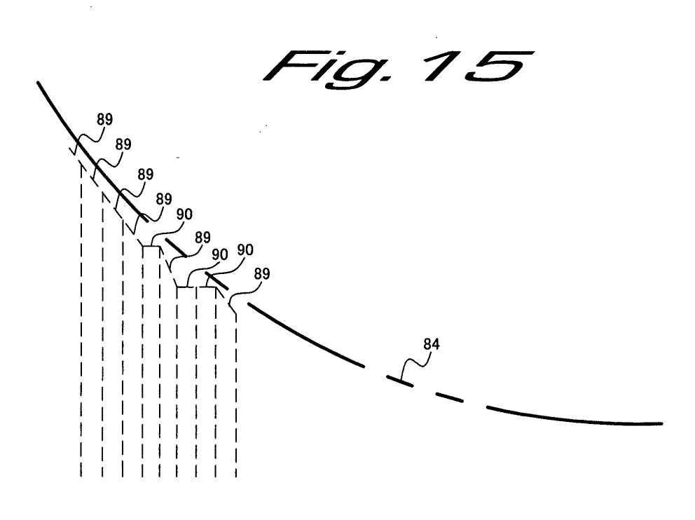

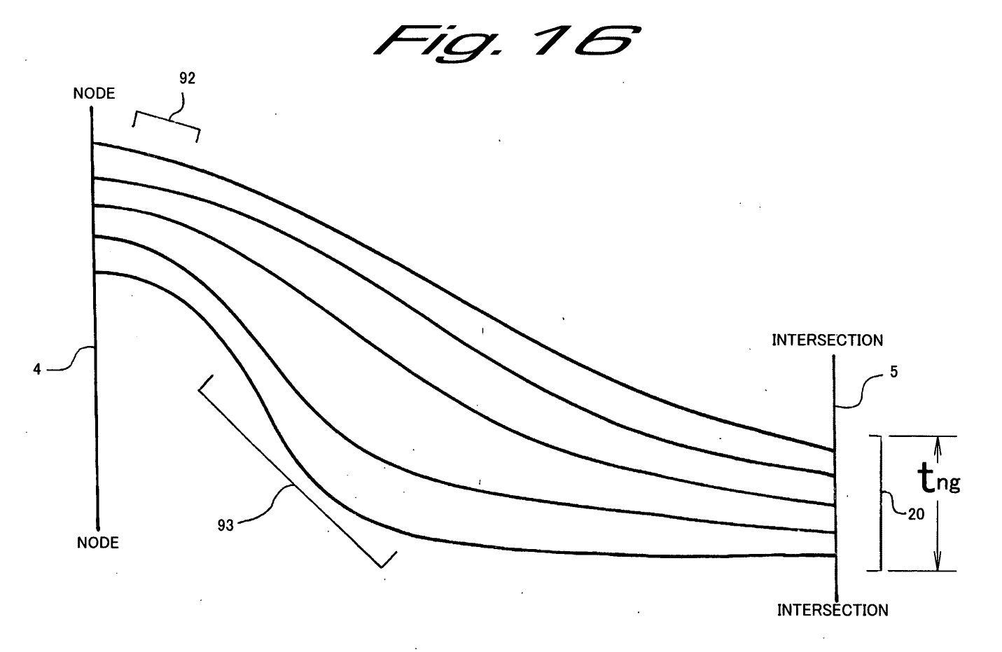

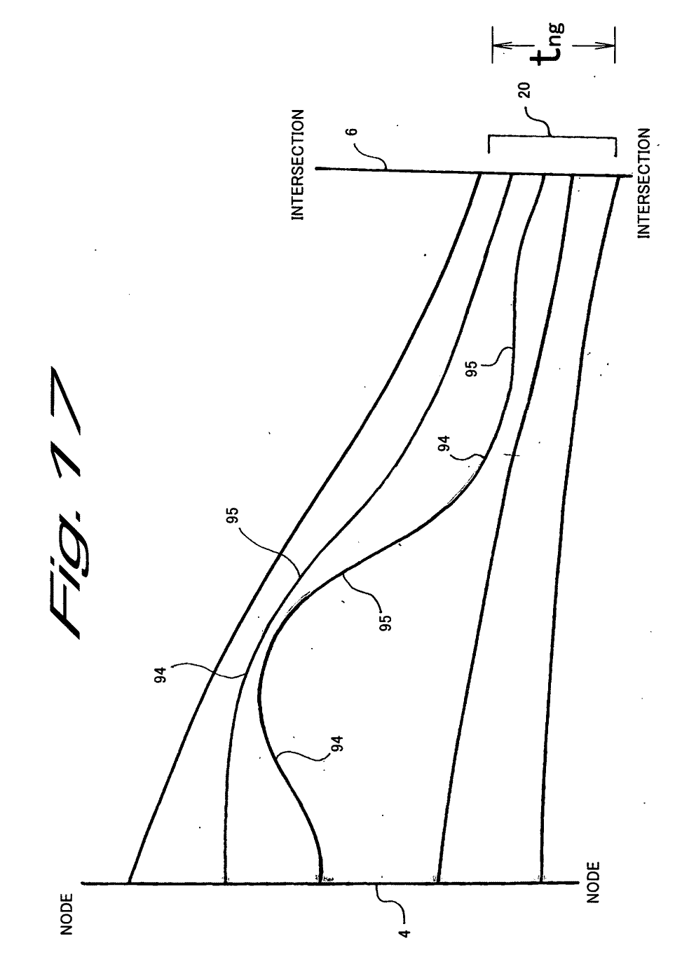

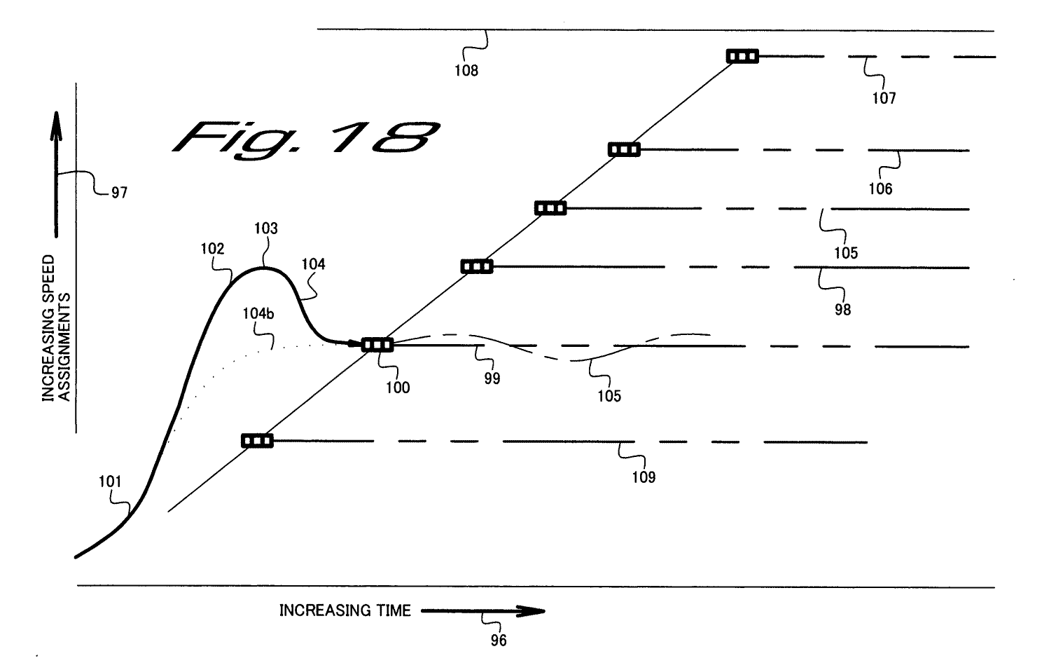

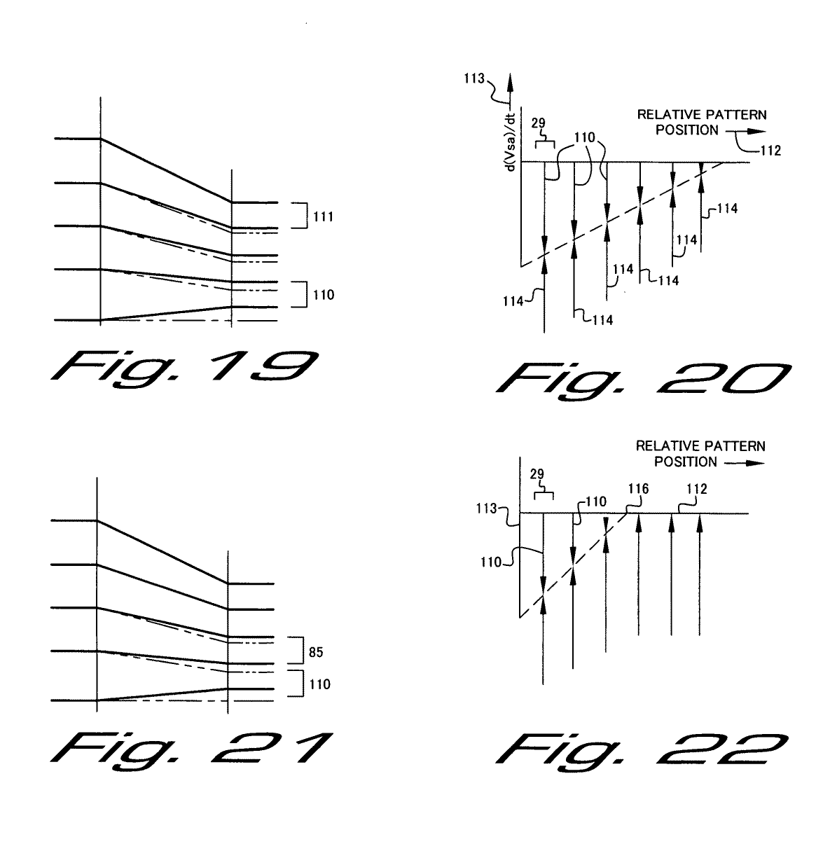

The basic parameters of not exceeding the speed limit, no cross assigning 29-c and compressing or consolidating traffic in the same proportion as it was when first encountered 12 (in [FIGS. 1, 5 and 6]) are shown. A distribution during a basic FLOW compression is also shown in [FIG. 7] including vehicles 40, 41, 42, 43, 44, 45. A close following condition is detected at the front of the FLOW pattern 47 and at the rear of the pattern 48. In [FIG. 8] more mobility is experienced, and particularly more safety is experienced when vehicles are better distributed while being traffic managed during, before, or both during and before compression. Vehicle 41 is shifted back 49 a reasonable measure to new position in FLOW hierarchy from its former relative position 41-b (by receiving slightly slower speed assignments) providing relief of close following condition 47. Vehicle 42 is shifted back 50 a little from its previous position 42-b in order that it maintains an optimal safe following distance between itself and rearward shifting vehicle 41. Since vehicle 43 is at an optimally proportional spot already, it substantially continues to receive standard FLOW readouts and standard FLOW compression/consolidation, with no further adaptive shifting within the relative FLOW pattern. Vehicle 44 is given a little faster speed assignments that cause it to shift forwards 51 (from its former position 44-b) and gain towards the front of FLOW pattern and provide for more following distance between itself and vehicle 45 which stays in the rear of the pattern and continues to receive standard FLOW readouts which maintain its already optimal spot in the FLOW pattern.

Not enough distance is perceived in FLOW pattern of [FIG. 9] at the lead of it for the lead vehicle 52. Therefore vehicle 52 shifts until there is enough following distance/reaction time to the beginning of the pattern. The following vehicles 53, 54, 55 shift in lesser amounts as compared to how much further back their position is in the pattern. Those proportional smaller progressive shift amounts correlate with the optimum maximum spacing within the pattern. All the vehicles in the pattern of [FIG. 9] shift in diminishing shifting amounts (forward to rear)except for the last vehicle 56 that remains in its standard relative proportional FLOW consolidation.

In [FIG. 10], a similar partial shift occurs with lead vehicle 57 except the pattern itself absorbs the trickle effect by the time the following vehicles, 58 and 59 compress. There is a short time to compress, and that combined with reasonably even distribution in the pattern allows for the rest of the vehicles in the pattern remain under standard FLOW consolidation without any further need for adaptations in the relative FLOW pattern.

Opposing (perpendicular) traffic patterns are detected to have different densities or amounts of traffic per time (Note that whenever “opposing or perpendicular” expression is used, it is a general implication to differentiate from “oncoming” opposing, and FLOW systems could just as easily work for angled streets and non-orthogonal streets such as NW-SSE vs. N-S, and so on). In [FIG. 11] the pattern coming from the North 60 has lots of density per its Pi and its Tng 61 is expanded 62 to a larger Tng 63 from where it was before 61b. Inversely, the pattern coming out of the West or opposite (perpendicular) direction 64 is matched for adequately lean traffic, and has lots of extra space in its Tng 65 and is contracted 66 to a smaller Tng 67 from where it was before 65-b. The red phase is shrunk for the pattern coming from the North as is the green phase from the West. While the green phase in the North is expanded 62 the red phase in the West also expanded so that the phases still are consistent and continuous with one another.

In [FIG. 12], many Boolean questions of “Expand or Contract?” are run per time. The actual ongoing summation point 68 causing a “drift” 69 towards expanding 70 in one direction and contracting 71 in the other. The drift 69 can go either way and as soon as the sum of the drift is far enough with confirmation, necessary reserve time buffers, and so on to commit, a complete place 72, which includes vehicle 73 and following distance 74, is added 75 to Tng 20. The overall processor 8 (in [FIG. 1]) also must subtract a place in the opposite (perpendicular) direction 65 (in [FIG. 11]) in a like manor. Any incomplete summation before a commitment is made for a full place can be absorbed by safety buffer time/space 22, 23 (in [FIG. 3]).

In [FIG. 13], traffic starts compression 80 and finishes compression 81 similar to that in [FIG. 3] except that starting 80 and ending 81 of compression takes place after the node 4 is crossed and well before intersection 6 causing all compression to take place in a distance 83 that is contained within the trap length X 28. Compressing within these bounds causes traffic 29,30,31,32,33 to form a pattern that more goes together as a group in a constant velocity more like all at once as opposed to a feeding-in condition as expressed in [FIG. 4]. Group feeds into Tng 20 as it goes through the intersection; and group allows for feeding in more joined together from random traffic pattern 34.

Instead of abrupt speed changes 80,81 (in [FIG. 14]) as assignments are undertaken or finished 80, 81, or 4, 6 in [FIG. 3], there can be gradual changes 84 in speeds that lend themselves to better safety. Going into gradual speed change 84 is constant speed 85, which is a function of the speed limit of the pre-consolidated random pattern 34. Curve of gradual change 84 makes a smooth transition from speed limit 85 to compression speed assignment 86. At the end of compression-speed assignment 86, gradual change at end of compression 84 transitions from compression speed 86 to constant speed near intersection 88. Also, gradual change 84 can happen very close to the intersection 6 (in [FIG. 3]) replacing abrupt change there. Similarly, the speed limit/assignment transition 84 at the beginning of the compression can replace the abrupt inflection right at the node 4 as shown in [FIG. 3].

Details of gradual change 84 can include a gradual transition from FLOW readouts to constant speed readouts by FLOW increments 89 interspersed with constant speed assignments 90. Each FLOW increment 89 is guided by the relationship of Vsa=X/[(Pi−Pa)+Pi+pgS−[1−((Pi−Pa)/Pi)Tng], while constant velocity increment 90 is governed by V=C where C is constant. The variation of times and places of FLOW increments versus constant increments is governed by the instantaneous location within the transition 84 along the position 28 (in [FIG. 13]) of where the vehicle is according to sensory based input. The same kind of transition can occur for the changeover from constant to FLOW readout 80 in [FIG. 13], or 4 in [FIG. 3]. Each increment (along the X axis) is based on an individual scan where there are many scans per time.

In [FIG. 16], a more dense part of a FLOW pattern 92 is given adaptive assignments 93 that more evenly distribute the pattern. Instances where the following distances are too close 94, in [FIG. 17] induce adaptive assignments that separate them better 95 as also shown in [FIGS. 7 and 8].

In [FIG. 18], a chart is shown that includes a “snap shot” for a mathematical enhancement that guides a “wayward”, “stray” or “straggling” vehicle from a previous FLOW pattern including for loose interpretation of node and trap. The chart includes progressed time 96 per speed assignment 97, with the previous minimum assignment 98 being displaced by a new minimum speed assignment 99 that was the wayward vehicle 100. At first, wayward vehicle must go very slow 101 in order to wait for the following FLOW pattern to catch up with it. As the following FLOW pattern catches up with it, speed for vehicle 101 increases 102, and even may exceed the normally assigned speed 103. Then the assignments gradually home in on 104 back to, or up to ideal speed assignment 99. The enhancement could just as easily level off 104b without exceeding over the speed assignment 99. Actual speeds 105 would continue to home in on the ideal speed assignment depending on the driver, output resolution and so on. Other ideal assignments include the previously minimal assignment 98, and with other following assignments 106, until the last and highest assignment 107 of the FLOW pattern which is at or under the prevailing speed limit 108. The other bound of the FLOW pattern is the beginning of existing Tng 109 which may be involved with one or more safety buffers (not shown).

Using an idealized version formats of [FIG. 3], [FIG. 4] et al, some of the more likely uses are shown out of the large number of possibilities for applying adaptive readouts and d(Vsa)/dt. The zone pattern of [FIGS. 7, 8, 9, 10] is shown as a shift in [FIGS. 19, 21], while distribution of d(Vsa)/dt vs. relative position in the pattern is shown in [FIGS. 20, 22]. At the front of the pattern, the d(Vsa)/dt changes the most 110; at the rear 111, the d(Vsa)/dt changes the least where the last vehicle does not change at all from the standard compression. In the event of any extra smooth or incremental space/steps as would be found in [FIG. 12], the safety time buffers (22, 23 in [FIG. 4 et al]; not shown in [FIG. 19 and up]), can serve to absorb extra summation. The chart of relative distance in the FLOW pattern 112 vs. d(Vsa)/dt 113 shows as vectors the most change in the lead vehicle 29, and shows it as a negative change. The default speed assignments are also shown as vectors 114. In [FIG. 21], the most change in d(Vsa)/dt is still at the beginning of the pattern 110 while the adaptivity of speed assignments are very small near the middle and cessation of d(Vsa)/dt occurs near the middle of the pattern 116 In [FIG. 22]. The lead vehicle 29 still has the most change in the negative direction with zero change (d(Vsa)/dt=0) near mid pattern 116. While the shrinkage of the whole pattern in [FIGS. 19, 20] and partial shrinkage [FIGS. 21, 22] are shown from the front of the pattern, they could just as easily be similarly shrunk from the rear of the pattern.

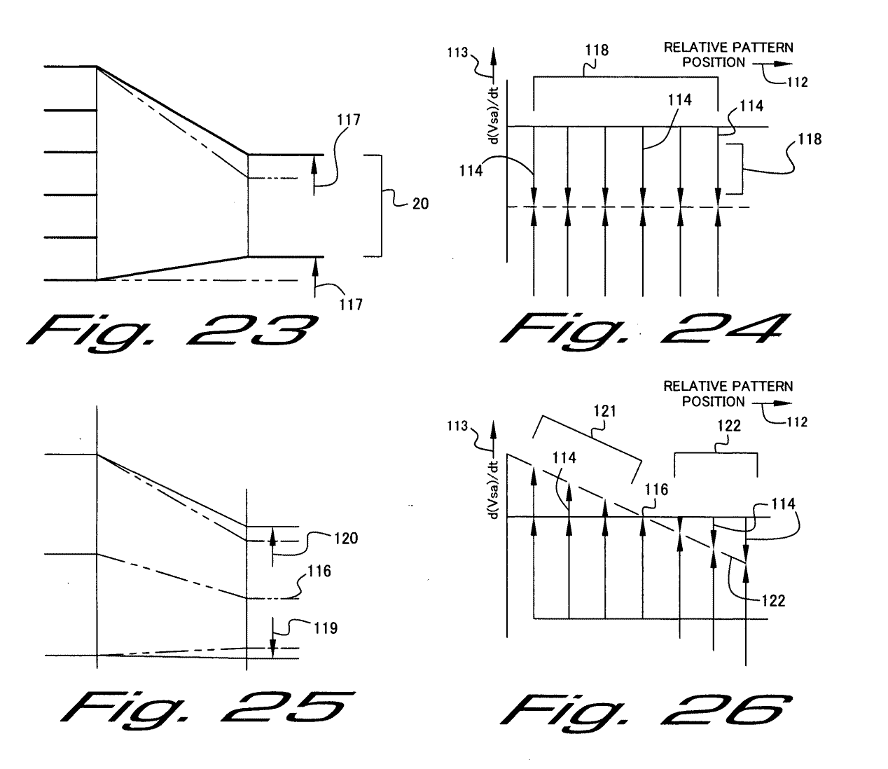

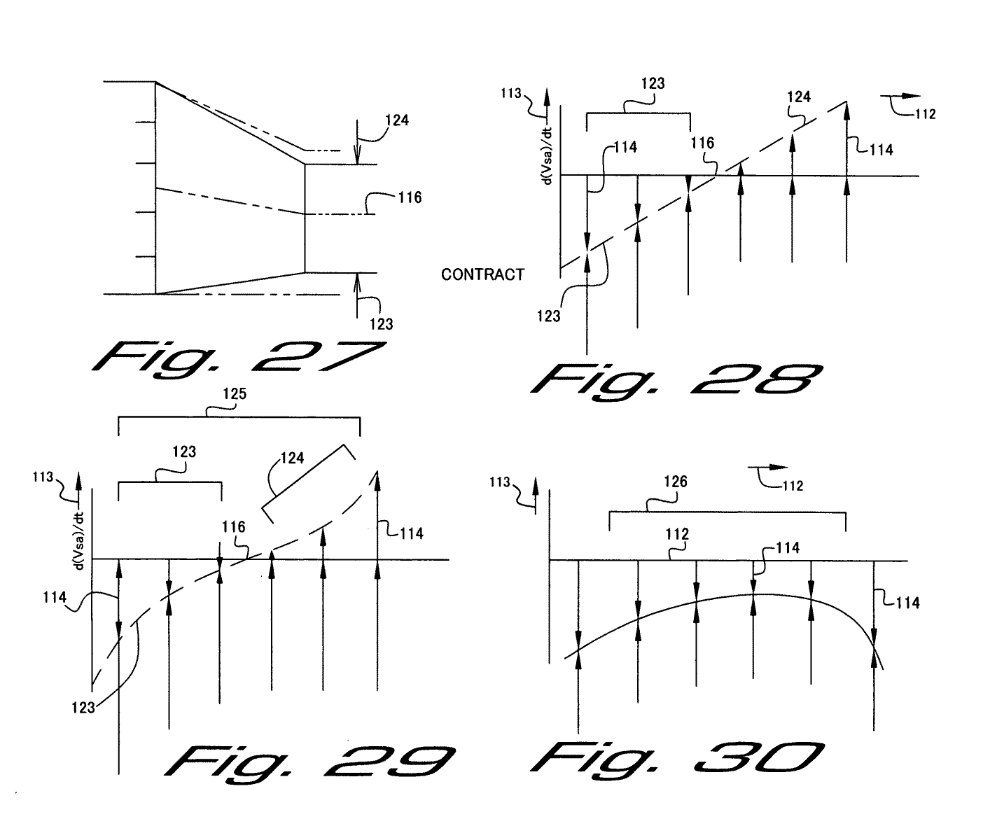

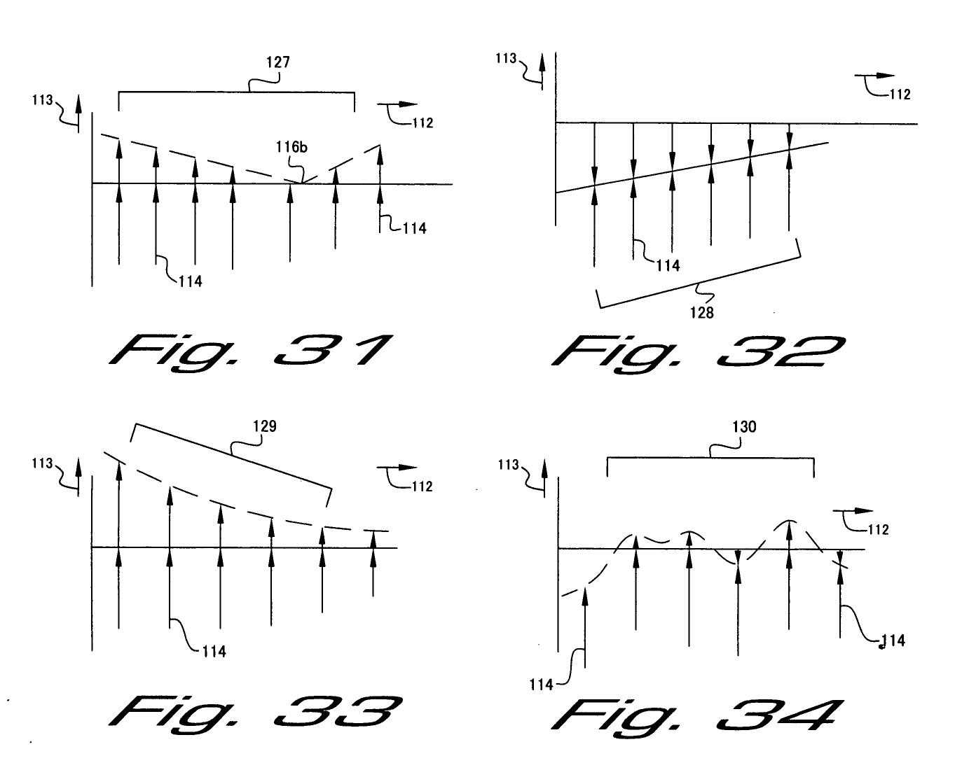

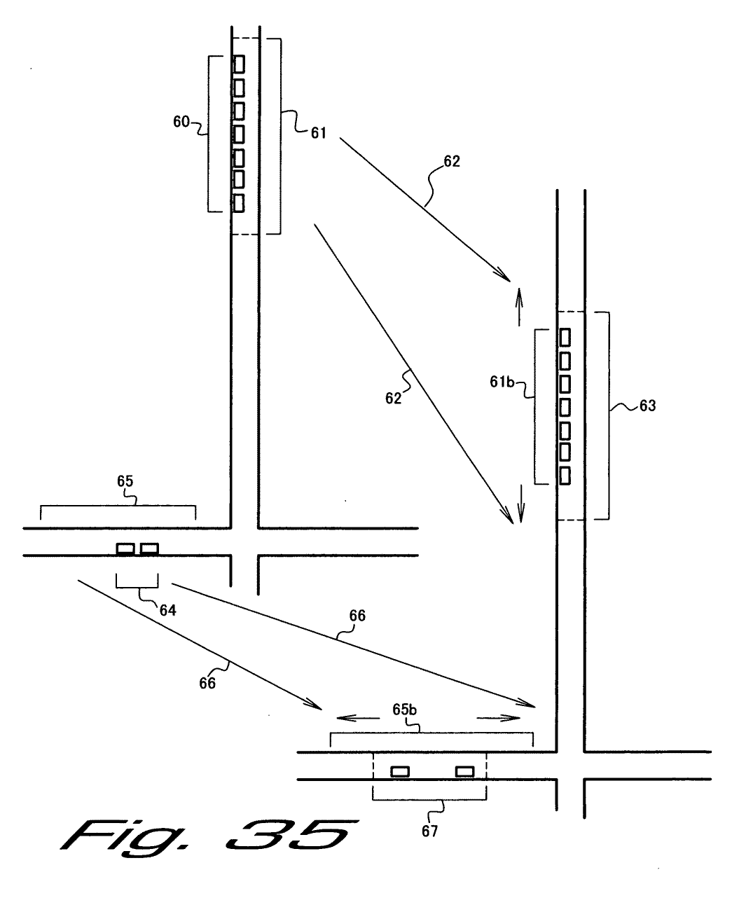

In [FIGS. 23, 24], the whole of Tng stays the same length but is shifted backwards 117. The Tng could just as easily be shifted forwards in the same manor. In [FIG. 24] all vectors of d(Vsa)/dt 114 have the same magnitude in the negative direction 118. Expansion is shown in [FIGS. 25, 26] where the front of the FLOW pattern is moved forward 119 and the rear of the pattern 120 is moved backwards with no d(Vsa)/dt change near center of pattern 116. For the first part of the pattern 121 in [FIG. 26] the d(Vsa)/dt are positive and for the second part they are negative 122. In contracting, the beginning of the pattern is slowed down 123 and the rear is speeded up 124 (in FIGS. 27, 28]) with d(Vsa)/dt=0 near center of pattern 116. While [FIGS. 19 through 27] essentially demonstrate straightness and symmetry in distributions of d(Vsa)/dt, there is a large likelihood that there would be curved distributions 125 (which also changes direction for compressing pattern) in [FIG. 29]. Also, it can be likely that distributions would be asymmetrical as shown in curved asymmetrical 126, and straight asymmetrical 127 as in [FIG. 30] and [FIG. 31] respectively. In straight asymmetrical 126, the center is at 116b where d(Vsa)/dt=0. In [FIG. 32], the pattern could be moved backwards unevenly but still with a straight distribution 128. The whole pattern is unevenly moved forwards with curved distribution 129 in [FIG. 33]. d(Vsa)/dt can change from faster to slower and back again many times 130 during traffic management. For example: in the case of close followers ([FIG. 34] and as corresponding to [FIG. 17]).

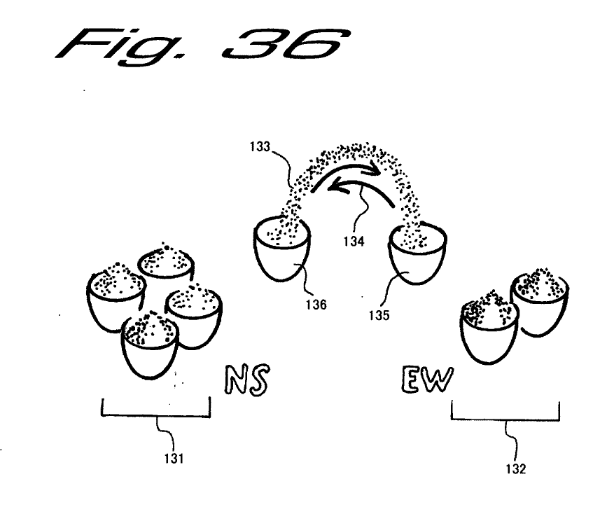

Straight 127 or curved 128, 125 d(Vsa)/dt distributions may be the result of rapidly changing Pi service cycle which changes all the phases including Tng in the North direction 61 to or from a longer Tng in the North direction 61-b in [FIG. 35], as well as changing the Tng from the West direction 66 to or from a shorter Tng in the West direction 66-b (Note that whenever “perpendicular” expression is used, it is a general implication and FLOW systems could just as easily work for angled streets and non-orthogonal streets such as NW-SE vs. E-W). As Pi changes to get longer, the phases equally spread out and the speed assignments can get faster; as Pi shortens, the phases get closer together and the speed assignments become slower (there also can be the condition where the phases/following distances get longer AND the assignments get slower). There is also the correlation that as phases and lengths expand with expanding Pi, that the distance of the node (especially the distinct definition 4 in [FIG. 1]) also expands.

The Tng of both North and West 9in [FIG. 35] can change smoothly as expansion or contraction. Also they can expand or contract as full increments with each increment expanding with a full place that includes a vehicle with its following distance. The changing back and forth of places can be demonstrated with a group of containers that represent NS 131, and one that represents EW132. Each scan is represented as a grain 133. As the scans can favor each direction, the grains 133 also switch 134, pouring and filling EW place 135 and NS place 136. If one or the other of containers 135, 136 get filled (and including necessary buffers) that extra container would go to one group and be taken away from the other.

Outside influences having effect on adaptive FLOW system can also be one of the methods of adaptation. The individual scans 133in [FIG. 36] can represent d(Vsa)/dt as coming from an outside source such as a larger network influencing a particular intersection or co-influencing that intersection. The outside toggle can influence direction of which container is being filled 134 and can either function in increments as in [FIG. 36] as well as [FIG. 12], or as a smooth transition as in [FIGS. 3, 4, 5, 6 14, 16, 19, et. al]. The rate of toggle can also be represented either as the steepness of a curve in the latter list for a smooth transition. For incremental rate of transition, i.e. smooth summation and conditional increment, the NON-steepness of the curving drift 69 in [FIG. 12] would represent the rate of toggle. That same rate in [FIG. 36] is depicted by either the variable thickness of the changing stream of individual grains 133 or just as easily the speed at which the individual grains 133 are being transferred transition can

What is claimed is:

1. A traffic management system comprising of:
A traffic signal governing an intersection using phase total including Red, Green, Yellow, (RGY), as well as an including other phase options such as left turn, green arrow, pedestrian walk, with a defined service cycle such that phases totals generally repeat themselves in a service cycle Pi (as in period of the intersection),
a FLOW (Fast Lane On Warning) sequencer operatively connected thereon, wherein said FLOW sequencer serves one or more lanes in one or more directions, a sensor based counter; traffic density-per-time processing means also operatively connected thereon,
wherein said processing means synthesizes information of status of incoming traffic including count, following distances, following times, count per unit time or density, density variation per the FLOW pattern, places where said density was high, places where said density was low, static waiting-at-intersection traffic count, waiting count per time, combinations thereof,
wherein sensing means senses for one or more FLOW lanes in one or more directions, and wherein said sensing means covers the run up for each FLOW lane,
wherein system can accommodate for sensors that sense at low frequency or can accommodate for sensors that sense to high frequency,
wherein said high frequency can allow for smooth transitions in the output or accurate feed-in data for incremental outputs
further, wherein said processing means can where appropriate, influence RGY type phase length, multidirectional phase tradeoff, overall periods, Pi,
readout; output; speed assignment methodology that includes emplaced roadside units (RSU) means, and/or vehicle-on board mobile readout means,
wherein said speed assignments start at a node, point or distinct threshold that is a particular distance up the road/run-up from the intersection at which point compression (per time) starts,
wherein said FLOW; Fast Lane On Warning readout means takes FLOW readout data from said FLOW sequencer operating in concert with said traffic signal, and tells individual vehicles what speed to go in order to make it through said traffic signal at said intersection while signal is in a green phase,
wherein said FLOW readout data comes as a repeating series that sums up to the same service cycle period Pi as said traffic signal RGY service cycle period Pi and with appropriate offset in starting time,
wherein no assigning causes said vehicles to exceed the speed limit
wherein assignments will not cross-assign one another, or where processes will attempt to not cross assign within the greatest extent allowed by limitations of resolution (of readouts per time), and thus,
wherein vehicles will substantially avoid passing or overtaking one another in the FLOW lane or pattern where said passing or overtaking may be due to speed assigning,
wherein because of said non-cross-assigning, that vehicles retain their hierarchical position as they are being consolidated or compressed especially at the beginning of said consolidation/compression, or wherein vehicles retain their said hierarchical position as they are first sensed and/or traffic-managed,
and wherein that initial hierarchy can be modified as consolidation/compression takes place in order:
A. to increase and to optimize safety; i.e to optimize following distances within the consolidation
B. to increase and optimize mobility; i.e. to further optimize green time per moving traffic,
wherein in the processes of being compressed, or before the processes of being compressed, that said hierarchy can be redistributed to optimize safety and mobility,
wherein FLOW readouts can be directly or indirectly influenced based on sensory input to redistribute traffic, pattern, and individual vehicles as well,
wherein the mechanism for the altered adaptive readouts is a positive or negative change in readouts from the hierarchical order that the vehicles of the pattern were in at the beginning of the consolidation or compression,
wherein adaptive pattern positions can converge or diverge from typical readout,
wherein FLOW patterns can be optimized based on sensory data
wherein safety can be further enhanced in the FLOW lanes,
wherein more vehicles can be allowed to remain in a higher energy state, more fuel conservation can be gained as a part of the infrastructure, and wherein the fuel consumption rate can be reduced at a local level.

2. The system of claim 1 except wherein there can be a looser interpretation of said node wherein instead of a distinct point, there can be a zone or range during which traffic begins to be compressed,
wherein traffic can be managed and/or compressed at different beginning points into the node, trap, or FLOW zone, or run up.

3. A FLOW (Fast Lane On Warning) system that tells motorist how fast to go in order to get through a green light of a signaled intersection,
wherein said FLOW lane serves one or more lanes in one or more directions,
a robotically influenced traffic management system wherein there is a basic autonomy relationship that determines the parameters of:
not exceeding the speed limit,
that there should be no cross assigning to the best degree within the limitations of resolution,
and that because of the preceding condition, that especially at arrival into where traffic management is beginning, that there is a proportion of position (in previously random approaching traffic) in hierarchy that is retained during start of traffic management,
and that during all or parts of when/where traffic is being managed, or before traffic is being managed there can be redistribution in the FLOW pattern to optimize for safe following distances, balanced density, maximum of open green time per moving traffic,
wherein the relation for autonomic base from which optimizations begin is:
$$Vsa = \frac{X}{( Pi - Pa ) + Pi + pgS - [ 1 - \frac{( Pi - Pa )}{Pi} ] Tng} \pm \frac{d ( Vsa )}{d t}$$
and wherein the adaptive modifying robotic function is
$$adaptive supplement = \pm \frac{d ( Vsa )}{d t} = \frac{{d}^{2} X}{d {X}^{2}} = {X}^{″}$$
Where Vsa=speed assignment,
X=distance to intersection,
Pa=arrival point in time that vehicle enters trap (i.e. crosses the node) and figures the necessary offset between the start of the Pi of the traffic signal and the Pi of the FLOW readouts,
Pi=service cycle period of intersection as well as FLOW readouts cycle,
pgS=pre green safety time buffer period that preceeds the FLOW pattern and can range form 0 to a reasonable period that can accept wayward traffic ahead of FLOW pattern, and wayward traffic from the tail of the previous pattern,
Tng=net green period where traffic goes through,
wherein there can be said safety buffer time period after said Tng, Tsf,
wherein said Tsf is created by shortening the duration of Tng such that
Tsf=G−Tng−pgS
and wherein Psf said safe following can range between 0 and a reasonable time to allow for wayward traffic instances including late stragglers still through on green phase and allow for vehicles turning onto trap after a FLOW pattern goes by,
wherein there is consolidation or compression in space and time from a random traffic filled pattern feeding into a trap or zone before said intersection, and wherein said compression leads to a net green moving space zone that goes through said intersection during a net green time phase,
and wherein during that compression part, the supplement: d(Vsa)/dt, or d̂2X/dX̂2, or X″ (second order derivative) allows movement within said compression to enhance more moving traffic in the net green, provide for more mobility, enhance better following distances of each vehicle in the pattern, accepts more vehicle places (while reducing places in the opposite perpendicular direction), accepts more vehicles out of the void or no-assignment places, combinations of any or all of those in this claim,
wherein there can be more mobility and more safety.
wherein form said autonomous base, robotic influences optimizations and actions can take place.

4. The system of claim 1 wherein the overall service cycle period of said traffic signal is influenced: either lengthened or shortened, due to sensory based inputs.

5. The system of claim 1 wherein the length of phases are influenced; either lengthened/expanded or shortened/contracted due to sensory based inputs.

6. The system of claim 1 wherein FLOW readouts are influenced. Due to sensory based inputs.

7. The system of claim 6 wherein readout influences include frequency or numbers of readouts per time or number of readouts per phase.

8. The system of claim 6 wherein the length of the relative following distance or space time can be increased or decreased,
wherein said readout length implies abilities for longer, or shorter, fragment of hierarchy or slot,
wherein said lengthening or contraction of said readout can be proportionally associated with expansion contraction of service cycle, or phases, or compensating phases (i.e. adding on one direction, taking away in opposing (perpendicular) direction), or any combinations thereof,
wherein said slots add up to phases, service cycles, changing summating compensating tradeoff phases,
wherein said increase or decrease includes capability for REPOSITIONING place in the hierarchy, following distances, number of slots intended for vehicles per phase, relative density in the FLOW pattern combinations of the above,
wherein variation of speed assignment determinations can be determined by sensory based inputs.

9. The system of claim 4 wherein service cycle of traffic signal is lengthened or contracted/shortened as well the associated phases and as well affiliated sets of FLOW speed assignments are either lengthened or contracted or can become more numerous,
wherein with the ability of slowed down speed assignments affiliated with longer Pi, longer slots, places, following space-times can result and extra safety can be incorporated within said system,
wherein more numerous slots can allow more traffic through during green phase,
wherein slowing down the speed assignments can allow for shorter Pi periods,
wherein more lengthy (space, time) slots/following distances associated with longer cycles and Pi and phases can allow for speed assignments that are faster.

10. The system of claim 5 wherein changing of length of phases, Tng can extend into or contract from either one of or both safety time buffers pgS and Psf,
wherein said extended Tng can provide for more numerous slots, or longer time duration slots, and provide for more mobility and green time per moving traffic,
wherein contracting of sensed lean Tng can increase time buffer size, and thus increase safety,
wherein safety time buffers can be increased thus leaving more room for wayward traffic to be received in FLOW patterns.

11. The system of claim 1 wherein frequency of scans for sensory data can range from specific individual incoming input compilations to overall unified data scans,
wherein such data can be taken at a time period reasonable enough as to effectively execute adaptability in a FLOW lane to scans many or more hundreds of times a second providing for a constant “vision”.

12. The device of claim 1 wherein speed assignments are adaptively changed or varied during the space and time that compression, convergence in speed assignments takes place.

13. The device of claim 1 wherein speed assignments can be adaptively changed or varied before compression, convergence takes place,
wherein adaptive changes can occur before encountering said node,
wherein traffic management can occur within the node but before consolidation or compression begins,
wherein traffic can be adaptively redistributed, moved about within the FLOW zone, pattern, “platoon” not only for being converging, compressed, but for solely being better distributed within said FLOW pattern as well,
and wherein the adaptively reassigned, repositioned vehicles could tend to be safer for compressing, converging.

14. The system of claim 5 wherein there is a proportional contraction associated with expansion in the opposite (perpendicular) direction, i.e. E-W vs. N-S,
wherein the expanding FLOW pattern and Tng can adapt to more or denser traffic, or contracting FLOW pattern and Tng could adapt to leaner or more sparse traffic per time,
wherein adaptation is applied to phases to account for denser to leaner, leaner to denser wherein green phase can be expanded in one direction while red would be equally expanded for the other opposite (perpendicular) direction (i.e. N-S vs. E-W), and red phase in the first direction would be proportionally contracted along with green phase in the opposite (perpendicular) direction,
wherein lesser dense Tng lengths can be shortened for less dense groups or FLOW patterns, and Tng in the opposite direction can be expanded for more dense groups or FLOW patterns,
wherein, expansion is proportional so that all phases still match on an instantaneous basis even though that some or all phases may be changing,
wherein associated distance or length as well as the time duration it takes FLOW pattern to pass by, could be expanded and contracted,
wherein more traffic can effectively be brought through while in the green cycle due to sensor based adaptability and influencing of opposing direction net green phases.

15. The system of claim 5 wherein places, slots, space-times associated with individual vehicles in a FLOW pattern can be added to or subtracted from Tng,
wherein place/slot may include a vehicle and along with its reasonable following distance,
wherein whole increments can be added in one direction and proportionately subtracted in the opposite (perpendicular) direction under the tradeoff condition,
wherein increment could apply to tradeoff function (i.e. if slots in one direction expand, the slots in the other contract),
or where whole Tng increments can be added to both directions together when Pi is expanding; subtracted when both are contracting as Pi is expanding contracting respectively,
or any other place in FLOW traffic management where increments with following distances might be appropriate.

16. The system of claim 5 wherein said slots each include a following space-time or relative distance, and wherein said space time or relative distance is figured by the time between the instant when a first vehicle passes a static reference point along the road and the instant a second vehicle passes it,
wherein there can be a determination of slot tradeoffs with a program that may have a high frequency of relative scans and which may use the condition of “Is there enough difference to warrant an increment that is the length of a slot?”, and once enough difference need was detected to open and close a slot respectively, the tradeoff in the opposing phases would be made,
wherein there could be enough buffer or prep or early sensing or combinations of those to avoid abrupt changes or going back and fourth between “place or no place”.

17. The system of claim 3 wherein said phases, especially net green, Tng and its associated FLOW pattern can be altered, compressed, expanded, altered in part, shifted backwards, or forwards, altered while feeding or spilling, differentially altered, differentially due to enhancements that are in addition to said basic equation, altered with multiple changes in direction (i.e. wherein d(Vsa)/dt changes positive to negative from FLOW autonomous readout multiple times), altered proportionately, non proportionally, adapted with d(Vsa)/dt is straight distribution, adapted with d(Vsa)/dt non straight distribution, or partially straight, or any combinations thereof,
wherein such alterations on the basic default foundation readout can allow for more safety and further mobility.

18. The system of claim 17 wherein said pattern is shifted backwards in space and/or time,
wherein said pattern is shifted back into said safety following buffer Tsf,
wherein there can be made more room in said pre-FLOW pattern safety buffer pgS
wherein extra waiting traffic waiting at said intersection can be accounted for,
wherein room can be made for turning on traffic into FLOW lanes and/or wayward stragglers.

19. The system of claim 10 wherein said FLOW pattern based on said equation (of claim 3) is contracted together, or expanded apart as a function of further enhancement,
wherein the center of the contraction (expansion) enhancement (i.e. the place where the vehicle responds to standard compression alone; where d(Vsa)/dt=0), could be at the center of the FLOW pattern,
wherein said center of contraction could be in other places in the FLOW pattern (i.e. 20% back from the start),
wherein other places could include either end of said FLOW pattern.

20. The system of claim 3 wherein there can be an additional condition where said Tng part of said relation can get smaller and smaller and function with only a few places,
wherein instead of d(Vsa)/dt the contraction is dictated by making the Tng function (as part of the default equation) smaller,
wherein the relation can still be smaller and smaller until said factor drops out and Tng zone becomes a point where:
$$Vsa = \frac{X}{( Pi - Pa ) + Pi + pgS}$$
wherein if the Tng function drops completely out, the placement of said point depends on how big the pgS is as to where said point is during green phase,
wherein said point as well as very small Tng becomes a target in the green phase
wherein said target can insure better probability that traffic makes it through a green phase in spite of any loss of resolution.

21. The system of claim 3 wherein there is an enhancement that can bring traffic from a void or empty space, or “vacated area” that precedes a FLOW pattern and especially traffic from a void that contains stragglers or wayward vehicles from a previous FLOW pattern and said previous Pi,
wherein at first there is slow assignments until following FLOW begins to get closer,
wherein there is included the possibility for gaining access into a FLOW pattern with variable and sensor based enhancements that include starting slow then going faster than the normal default speed assignment, going slow again as necessary for a smooth transition into a gaining FLOW pattern, especially a following one in a following Pi,
wherein it is also possible for the enhancement to not exceed the default speed assignment but to approach up to it as the newly open slot of the following FLOW pattern gains on said wayward vehicle,
wherein said FLOW pattern involvement will still allow vehicles to go through the green phase with high energy, less fuel expenditure, and less pollution emissions,
wherein there can be option of further slots that can repeat the enhancement with appropriate modifications for each slot,
wherein there can be more traffic from voids that can make it through a green phase and wherein the system can have more mobility.

22. The system of claim 2 including the looser interpretation of said node,
wherein there can be considered that the position in the run up is taken along with each scan of X as a “moving threshold”
wherein said starting time offset of Pi (RGY) vs. Pi (FLOW readouts) is reevaluated for every new scan of location X
wherein there is a possibility for each fast scan of precise counters and sensors to more easily distribute traffic throughout a FLOW pattern,
wherein looser interpretation of node can adapt especially well with high volumes of oncoming wayward traffic,
and wherein there is a possibility for more evenly distributed traffic in the event of much wayward traffic joining in FLOW pattern and wherein there is less likelihood of overloading overstuffing buffers with said larger amounts of wayward traffic,

23. The system of claim of claim 1 wherein there can be redistribution from more dense heavy traffic areas (i.e. per time) in the FLOW pattern to less dense areas in the FLOW pattern,
and wherein following distances can be better distributed in said pattern and wherein said patterns and lane will be safer.

24. The system of claim 1 wherein sensory means can detect overly close following distances and adaptively adjust FLOW readouts to encourage more distance between said close followers,
and wherein said following distances in the FLOW pattern will be safer,

25. The system of claim 1 wherein modifications of otherwise standard, baseline readouts take the form of modified readouts, algorithms as modified FLOW sequences or speed assignments,
by adding shifts algorithms, enhancers, enablers other types of influences to the FLOW status outputs and/or speed assignments,
wherein standard emplaced readouts and mobile receiver/calculator/readouts methodology used in non robotic FLOW systems and sequencers can be easily upgraded to robotic systems,
wherein modification to FLOW sequencer that processes adaptive readouts can be connected to FLOW sequencer, modem, or wireless link/transmitter in parasite or piggy back fashion,
wherein adaptive processes can modify said readout means,
wherein adaptive processes can modify from FLOW sequencer,
wherein said modified readouts processing can include being “instead of or “along with” or “as” modified FLOW sequences

26. The system of claim 1 wherein devices can be added in with existing systems
wherein robotic sequencer can be adaptive with existing mobile units by virtue of similar sentences to reflect adaptivity, adaptive algorithms, on-board-sensory based algorithms, and other solutions that could generate from mobile readouts,
wherein adaptivity can be imported by virtue of new sentence types, but still mixed with old sentence types wherein both new and old types of readouts can both receive readout information that would output universally as adaptive,
wherein adaptivity would be backwardly compatible,
wherein newly adaptive hardware can be used with existing infrastructure

27. The system claim 1 wherein there is possibility for master slave relationships and the use of precedence
wherein in a default condition the traffic signal has precedence over readout activity and FLOW sequencing activity,
but wherein there is a possibility for said sensor based processor counter to take precedence over traffic signal Pi, phases, perpendicular road phase supplemental relationships (i.e. N-S vs E-W), size of Tng and associated time buffers in order that those phases can be adapted to optimizing under sensed conditions,
wherein said master slave precedence conditions can include the counter/processor being the master and said traffic signal, phases, readouts being slave, as well as traffic signal being master and readouts being slave,
wherein there is an option when necessary for safety features that warrant said traffic signal to take precedence over all other processing when danger is present,
wherein it is possible for safety features to take the highest priority,
wherein when said phases, Pi, readouts can be adapted, there can be more mobility as a function of and result of said adaptability.

28. The system of claim 3 above wherein traffic managed vehicles can be treated as transitioning from one state of traffic management to another but not at the same time,
wherein transitions states can include random approaching pattern, crossing the node/threshold, entering into a looser interpretation of node or zone, beginning FLOW compression, ending FLOW compression, arriving at or near intersection, diverging away after going through the intersection,
wherein vehicles are not being fed in at the same time, but one before the other, causing early vehicles to go through transition before later ones in a “feeding” or “spilling” condition.

29. The system of claim 28 wherein while under consideration of feeding condition, that robotic adaptations can occur on a differential basis wherein certain ranges or portions (as well as whole) of fragments and cycles and phases, and slot length, and slot numbers can be sensor based, effected, processed, and result in adaptive action,
wherein said differential basis applies to sensor based adaptivity on a per time basis,
wherein examples may include d(ratio of NS vs. EW)/dt; d(Pi-changing-effect)/dt; d(phase opening or closing effect)/dt; d(Tng expand or contract)/dt; d(add or subtract to buffer time)/dt; d(count or number of slots in a Tng)/dt; d(length of slot)/dt; and other applicable differential of phases fragments portion with respect to time,
wherein there is a possibility of feeding condition differential based adaptation which uses differentials other than time, and wherein examples may include d(relative distance within pattern)/d(count); d(ratio of earlier density/present density)/d(relative distance),
wherein feeding adaptations can be algebraically expressed including for example “running count total NS/running count total EW/accumulating Pa”.

30. The system of claim 1 except wherein the FLOW pattern modification time and range are larger than the compression part,
wherein compression can be finished at a point substantially before pattern reaches said intersection, and/or compression can start after being in a trap where traffic is still being rearranged, but not yet compressed,
wherein traffic can be managed wherein aggregate velocity near the traffic signal is substantially the same wherein convergence of speed assignments might transition onto a pattern or “platoon” early enough that it can travel through the intersection substantially at constant velocity instead of a “spilling” or “feeding” condition,
wherein if compression finishes before vehicles go through intersection, spilling feeding effect can be minimized; continued converging can be minimized and aggregate velocity of pattern near intersection can be substantially constant, and wherein said constant speed can provide for better safety wherein drivers can better focus on going through the intersection,
wherein due to said earlier handling of traffic before compression and finishing compression before said intersection will provide for safer travel in the FLOW lanes.

31. The system of claim 1 wherein there is a possibility for smooth transitions of velocity during any changing of speeds to gain into a FLOW pattern or transition within a FLOW pattern, i.e. transitioning into or out of converging FLOW compression speed assignments,
wherein change from convergence of speed assignments or other changes or transitions can also become gradual.

32. Of claim 31 wherein mathematical enhancements may include the use of sensor based location varying from one transition of one speed “go constant”, to other speed “go convergent” in transition from 100% “go constant” at beginning of what is substantially a trap (from substantially the speed limit), 0% convergence to 100% “go constant” to 100% “go convergent” 0% “go constant” at the beginning of full convergent speed assignments; then at the end of convergence: from 100% go convergent, 0% “go constant” gradating onto 0% convergent 100% “go constant” where said “go constant” may be an aggregate velocity at essentially the end of FLOW compression, and could be a substantially constant speed,
wherein enhancements could include apply to transition back to the speed limit after proceeding through the light using similar mathematical enhancements, gradation or variation as described in this claim,
wherein above or similar enhancements could be used to smooth velocity changes (due to speed assignments) in algorithms for regaining vehicles that were in a void back into a FLOW pattern,
wherein the above or similar enhancements could substitute abrupt speed changes in other instances of traffic management.

33. The system of claim 1 wherein said processor can be influenced by sensors that effect other phases aside from typical RGY such as would include pedestrian walk, green arrow, left turn sub phase, and wherein walk prompts, setting traffic waiting at said intersection (i.e. as detected by existing static detecting/sensing loops) can influence said processor to expand and contract net greens accordingly,
and wherein with certain existing detecting means, adaptive systems can be integrated with existing infrastructure.

34. The system of Claim (above) wherein said system applies appropriate allied traffic managed applications including intersections with pantographed vehicles, tracked vehicles, busses, trams, trolleys, marine, drawbridges, one lane roads, bridges, bicycle, walking, pedestrian.

35. The system of claim 1 wherein there are mathematical enhancements that manage individual vehicles in voids, empty spaces, “vacated areas”, or otherwise spaces and times that would not normally be included in normal autonomic readouts,
wherein enhancements function in anticipation of an oncoming FLOW pattern,
wherein said pattern approaches said vehicle with enhanced readout, said vehicle is smoothly transitioned into said approaching FLOW pattern, “platoon” in an anticipated condition,
wherein vehicles are brought into FLOW pattern smoothly and wherein lead vehicles in said FLOW pattern do not have to slow down as vehicle ahead of pattern will not be in their path as a function of assignments,
and wherein said wayward vehicle(s) is brought into the following FLOW pattern with the optimum degree of safety and ease of handling.

36. The system of claim 35 wherein said enhancement involves the equation:
$$Vsa = \frac{X}{( Pi - Pa ) + Pi + pgS - [ 1 - \frac{( Pi - Pa )}{Pi} ] Tng} \pm \frac{d ( Vsa )}{d t}$$
Where Vsa=speed assignment,
X=distance to intersection,
Pa=arrival point in time that vehicle enters trap (i.e. crosses the node) and figures the necessary offset between the start of the Pi of the traffic signal and the Pi of the FLOW readouts,
Pi=service cycle period of intersection as well as FLOW readouts cycle,
pgS=pre green safety time buffer period that proceeds the FLOW pattern and can range form 0 to a reasonable period that can accept wayward traffic ahead of FLOW pattern, and wayward traffic from the tail of the previous pattern,
Tng=net green period where traffic goes through,

37. The system of claim (above wherein except with mathematical enhancements or the like influencing traffic that might be ahead of said FLOW pattern, said mathematical enhancements will influence traffic to the rear of said FLOW patterns,
wherein sensors can detect late traffic, apply Boolean conditionals, and if it is ascertained that individual FLOW-chasing-vehicles can still make the FLOW pattern in front of it without exceeding speed limits, said chasing vehicles will be given assignments that catch it into said FLOW pattern that is ahead,
and wherein if said Boolean conditionals determine that traffic will not safely be caught up to said FLOW pattern ahead, they will be deferred to the next following FLOW pattern which would use appropriate enhancements for vehicles that have FLOW patterns approaching from behind,
wherein with such said enhancements that dictate beginning and ends of FLOW pattern can stretch all through the total cycle and still bring traffic through on the green phase.

38. A FLOW traffic management system of claim 1 that redistributes a particular but very common occurrence of a release of static traffic pattern from a red light,
wherein said release from red spills into the run up of a FLOW lane,
wherein sensing can include one or the other or a combination of sensing moving vehicles on the fly and/or beginning with a static count of traffic,
wherein said static count can be at substantially the full amount stacked at said red that may be a substantial maximum number of vehicles that could be released, or down to a single or few vehicles,
wherein there is a likelihood of a denser part of a FLOW pattern at the rear of said distribution and having been caused by a startup from dead stop having been caused by a release from red traffic signal, and wherein there may be a thinner part of a distribution at the beginning of the FLOW pattern,
wherein there is distribution of vehicles with decreasing following distances towards the rear of the pattern and increasing following distances towards the front of the FLOW pattern due to having been released in a typical feed-out kind of situation from a stopped and released pattern,
and wherein typical average following distances are instinctively chosen by individual motorists,
wherein FLOW adaptive readouts that spread out following distances (as in claim # . . . ) can begin to kick in as traffic begins to move in a pattern, and especially as the pattern is all in motion,
wherein there can be a semi autonomous network of at least two (or more) signals with one of them being a released red coordinated with a robotic adaptive approach FLOW system that spreads out said release on red distribution,
wherein released red network can be coordinated with said FLOW adaptive approach that can be a leading signal of a green wave,
wherein said pattern can be safer as a result of safer distribution of following distances as a result of FLOW readouts,
wherein there could be more mobility afforded in an inter city setting because of a FLOW system being placed downstream of a released red light and releasing static waiting traffic.

39. A FLOW traffic management system that tells vehicles how fast to go in order to get through green phase,
including an external toggle means to begin action to increase or decrease components, and factors that can optimize green time per moving traffic,
wherein the word toggle applies to “holding down a switch to perform action; and having the action stop when switch is released”, and left to resume autonomy or independent adaptive operation,
wherein said toggle means includes examples of increase or decrease Pi, increase or decrease of phases, or increase or decrease readouts in number and/or readout/slot size, or any combination of Pi phases, and readouts/slots, length or frequency,
wherein there is a possibility for changing phases in a compensating condition, wherein an example includes N-S direction expanding while at the same time, E-W is contracting,
wherein there is an option that said toggle means includes the program that increments said opposite (perpendicular) direction compensating condition by full space times for slots wherein a whole slot is compensated for before a change is outputted,
wherein there are other options including for example, “more places being inserted as overall speeds can be slowed down so the places would not need to be as long and therefore allow for extra place increments”.

40. The system of claim 39 wherein there is the possibility of including a “How much?” and/or “At what rate?” and/or “At what priority?” factor,
wherein more magnitude for rate of change in sensing would translate to more magnitude in rate of change for said factors,
wherein system can change at differing rates of increase or decrease
wherein system can change automatically the rate of increase or decrease based on traffic density difference ratios i.e. if the ratio of differing densities or count per time is small, the rate of change is slow; if the ratio of differing densities or count per time is large, the rate of change is fast.
wherein said factors effecting such magnitude change rates include different installations of system; different roads; different directions; differing number of lanes; different portions; increase, decrease of Pi; increase, decrease of phases; compensatory phase increases, decreases; increases, decreases in readout numbers per Pi or per time; increases, decreases in readout slots/following distances; and other applicable changeable components,
wherein there is a possibility that toggle may be internally actuated as may be found with autonomous systems, including sensors, and controls,
wherein there is a possibility that said toggle may be externally actuated as may be found with network induced desire for changes in Pi, phases, readouts or combinations thereof,
wherein there is a possibility that said toggle may be additionally externally actuated as may be found with manual actuation,
wherein there is the possibility of manual inputs in synergy with adaptive or robotic functions, with variation of influences ranging from favoring influence of manual inputs to favoring influences of adaptive robotic functions,
wherein interfaces can be applied to change or influence said phases, parts of service cycles, portions of phases,
wherein interfaces can influence whole service cycles,
wherein interfaces can influence parts of FLOW readouts, wherein FLOW readouts can be influenced in number or cycle length,
wherein toggling is not too fast as to cause break in continuity or be dangerous,
wherein said toggling can be to make conditions safer to counter emerging dangerous conditions including increasing overall traffic density, ice, rain, fog, snow.

41. The system wherein said toggle means of 39 is used to output in full increments and includes a multi scan condition per second or a thousands of scan per second condition of count,
wherein there is a possibility of a conditional in whether or not a threshold has been reached; and wherein that threshold is a big enough sum for a complete slot or place,
wherein if the magnitude has not been reached that another scan is initiated and wherein if the magnitude has been reached, that the increment is applied,
wherein said increment can include an option of applying to a compensating or trade off for each opposing (perpendicular) direction; the adding of a slot to a Tng,
wherein there is a possibility that said conditional can work with the necessary anticipation functions and buffer/margin functions that would prevent jumping back and forth from one state to another, i.e. offset numbers of opposite (perpendicular) direction in the same run of a pattern, or the total number of places in a pattern,
wherein such safety and buffer functions will provide for more safety, reliability and ease of use.

42. The system of claim 16 wherein while said determinations are being made for whether slot increment is complete or not, said buffers (i.e. pgS, Tsf) can absorb extra time (space) difference.

43. The system of claim 4 wherein said Pi can be expanded or contracted in conditions that would be advantageous including:
wherein Pi expands and allows for slower speeds, wherein said expanded Pi along with slower speeds can provide for more safety by increasing reaction time as a function of distance and as a function of time,
wherein Pi expands and allows for faster speeds, wherein said expanded Pi with faster speeds substantially keeps the same reaction time while allowing faster speeds, and wherein there is slightly more mobility and somewhat less fuel consumption,
wherein Pi contracts and allows for slower speeds, wherein the reaction time of speeds when they were fast is substantially preserved (of if decreased, would still be within safe bounds), and wherein said slower speeds can provide for more safety
